(19) United States
(12) Patent Application Publication
(10) Pub. No.: US 2014/0195453 A1
(43) Pub. Date: Jul. 10, 2014

(54) SYSTEM, METHOD, AND APPARATUS FOR MANAGING FLUID TRANSPORTATION

(71) Applicant: Shalewater Solutions, Inc., Bridgeport, WV (US)

(72) Inventors: James Chance Richie, Leander, TX (US); Adam M. Klenk, Morgantown, WV (US)

(21) Appl. No.: 14/095,043

(22) Filed: Dec. 3, 2013

Related U.S. Application Data
(60) Provisional application No. 61/733,080, filed on Dec. 4, 2012.

(51) Int. Cl. G06Q 10/08

(52) U.S. Cl. CPC G06Q 10/0832
USPC 705/332

(57) ABSTRACT

A system, method, and apparatus for managing fluid transportation includes at least one client device configured to receive fluid source data from at least one fluid source data resource at a pick-up location and receive fluid destination data from at least one fluid destination data resource at a drop-off location, and at least one server computer in communication with the at least one client device, the at least one server computer configured to receive fluid data comprising at least a portion of the fluid source fluid data and at least a portion of the fluid destination data from the at least one client device, store the fluid data, and generate at least one report based at least partially on the fluid data.

### CROSS REFERENCE TO RELATED APPLICATIONS

This application claims benefit of priority from U.S. Provisional Patent Application No. 61/733,080, filed Dec. 4, 2012, which is incorporated herein by reference in its entirety.

### BACKGROUND OF THE INVENTION

1. Field of the Invention

This invention relates generally to fluid transportation management and, more specifically, to a system, apparatus, and method for managing fluid transport from source locations to destination locations.

2. Background of the Invention

Traditional methods for managing and tracking fluid transportation include the use of written manifests. These methods often result in errors and omitted steps or stages during transportation. Regulatory authorities, such as the Environmental Protection Agency (EPA) and the Department of Environmental Protection (DEP) for states, require hauling companies to track water sources and uses during drilling/fracturing (or “frocking”) activities.

Additionally, trucking costs are difficult to track using manually written manifests. Trucks are often rented or leased by trucking companies on an hourly basis and there is no way to verify the hauling time for each truck. This results in lost data and affects the number of hours that parties pay trucking companies.

Fluid transportation also presents difficulties in assigning each cost associated with fluid movement to the correct destination. In transporting drill/fracking water, or clean water, in connection with drilling/fracking activities, it is important to assign each cost with a correct well name and/or number. Energy and petroleum companies must properly assign these costs to the correct well because each well can have different ownership interests.

Therefore, there is a need for a method, apparatus, and system for managing fluid transportation to address some or all of the above-mentioned drawbacks.

### SUMMARY OF THE INVENTION

Generally, the present invention provides systems, apparatus, and methods for managing fluid transportation that address or overcome certain drawbacks and deficiencies existing in known management systems, such as known water transportation and management systems. Preferably, the present invention provides systems, apparatus, and methods for managing fluid transportation by receiving fluid data on client devices, and managing the fluid data on or with a server computer.

According to one preferred and non-limiting embodiment of the present invention, provided is a system for managing fluid transportation, comprising: at least one client device configured to: receive fluid source data from at least one fluid source data resource at a pick-up location, the fluid source data comprising at least two of the following: a fluid volume, a fluid type, a fluid flow rate, a pick-up location identifier, a pick-up location name, geographic coordinates of a pick-up location, a pick-up time, a pick-up date, or any combination thereof; and receive fluid destination data from at least one fluid destination data resource at a drop-off (or delivery) location, the fluid destination comprising at least one of the following: a fluid volume, a fluid type, a fluid flow rate, a drop-off location identifier, a drop-off location name, geographic coordinates of a drop-off location, or any combination thereof; and at least one server computer in communication with the at least one client device, the at least one server computer configured to receive fluid data comprising at least a portion of the fluid source fluid data and at least a portion of the fluid destination data from the at least one client device; store the fluid data; and generate at least one report based at least partially on the fluid data.

According to another preferred and non-limiting embodiment of the present invention, provided is a computer-implemented method for managing transportation of a fluid, comprising the steps of: receiving, on a mobile device, fluid source data from a fluid pick-up location, the fluid source data representing at least two of the following: a type of fluid, geographic coordinates of the pick-up location, a name of the pick-up location, an identifier of the pick-up location, a volume of the fluid, a pick-up time, a fluid pick-up date, or any combination thereof; receiving, on the mobile device, fluid destination data from a fluid drop-off (or delivery) location, the fluid data representing at least one of the following: geographic coordinates of the drop-off location, a name of the drop-up location, an identifier of the drop-off location, a volume of the fluid, a drop-off capacity, a drop-off time, a drop-off date, or any combination thereof; and transmitting, to at least one server computer, at least a portion of the fluid source data and the fluid destination data.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of a fluid transportation management system according to the principles of the present invention;

FIG. 2 is another schematic view of one embodiment of a fluid transportation management system according to the principles of the present invention;

FIG. 3 is a further schematic view of one embodiment of a fluid transportation management system according to the principles of the present invention;

FIG. 4 is a view of a login interface according to the principles of the present invention;

FIGS. 5A, 5B, and 5C are views of menu interfaces according to the principles of the present invention;

FIG. 6A is a view of a truck scan interface according to the principles of the present invention;

FIG. 6B is a view of a truck details interface according to the principles of the present invention;

FIG. 6C is a view of a location scan interface according to the principles of the present invention;

FIGS. 6D-6F are views of location details interfaces according to the principles of the present invention;

FIG. 6G is a view of a pick-up confirmation interface according to the principles of the present invention;

FIGS. 7A, 7C, 7E, and 7G are views of report generation interfaces according to the principles of the present invention;

FIGS. 7B, 7D, 7F, and 7H are views of report interfaces according to the principles of the present invention;

FIG. 8A is a view of a location map search interface according to the principles of the present invention;

FIG. 8B is a view of a map interface according to the principles of the present invention;

FIG. 9A is a view of a management menu interface according to the principles of the present invention;

FIGS. 9B-9D are views of user management interfaces according to the principles of the present invention;

FIGS. 10A-10B are views of trucking management interfaces according to the principles of the present invention;

FIG. 11A is a view of a location management interface according to the principles of the present invention;

FIG. 11B is a view of a well management interface according to the principles of the present invention;

FIGS. 12A-12E are views of management report generating interfaces according to the principles of the present invention;

FIG. 13 is a schematic diagram of a computer and network infrastructure according to the prior art;

FIG. 14 is a schematic view of one embodiment of a fluid transportation management system according to the principles of the present invention;

FIGS. 15-17 are views of client device interfaces according to the principles of the present invention;

FIGS. 18-19 are views of manifest application interfaces according to the principles of the present invention;

FIGS. 20-27 are views of management interfaces according to the principles of the present invention; and

FIGS. 28-38 are views of mobile administrative interfaces according to the principles of the present invention.

### DESCRIPTION OF THE PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible.

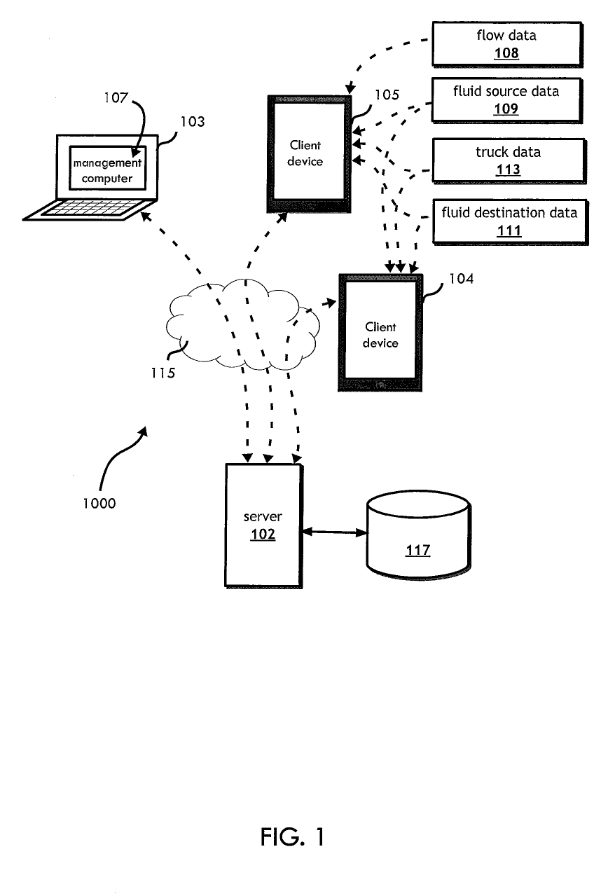

Referring to FIG. 1, a fluid transportation management system 1000 is shown according to one preferred and non-limiting embodiment. A server computer 102 is in communication with a management computer 103 and client devices 104, 105 through a network environment 115, such as the internet and/or a private network. The server computer 102 is also in communication with a fluid management database 117, including fluid data stored in the database 117. The management computer 103 displays a management interface 107 based at least partially on data received from the server computer 102 and/or the fluid management database 117. The management interface 107 may be used to view and generate reports based on the fluid data, as an example.

With continued reference to FIG. 1, the client devices 104, 105 are in communication with several types of fluid data, including fluid source data 109, fluid destination data 111, truck data 113, and flow data 108. In a preferred and non-limiting embodiment, the fluid source data 109 is included in a data resource that is proximate or otherwise associated with a fluid source (e.g., a fluid pick-up location), such as but not limited to a river, pond, or stream for fresh water, or a well for drilling/fracking water. The fluid destination data 111 is proximate to or otherwise associated with a fluid destination (e.g., a fluid drop-off (or delivery) location), such as but not limited to a pit, pond, water treatment facility, well, and/or the like. The truck data 113 is proximate to, affixed to, or otherwise associated with a truck or other vehicle, piping network, or other means used for transporting or facilitating the movement of the fluid. The flow data 108 may be received from any number of flow meters or other measurement equipment associated with the truck, a pick-up location, a drop-off location, a piping network, and/or the like.

In one preferred and non-limiting embodiment of the present invention, the fluid transportation management system 1000 allows users, managers, trucking companies, oil and gas companies, and/or the like to track and manage the transportation of fluids. In one example, all hauling and fluid transfer costs incurred in connection with the well drilling and/or fracturing processes may be associated with a particular well or site. By associating these costs with a well name, for example, the system 1000 allows for easy integration into accounting solutions used by various oil and gas companies.

As used herein, the term “fluid” may refer to any type of transportable fluid substance such as, but not limited to, wastewater, freshwater, sewage, flowback water, produced water, treated water, drill water, contaminated surface water, and/or the like. In a preferred and non-limiting embodiment, fluid refers to water used in the hydraulic fracturing process used for obtaining natural resources from the earth, including fresh water that is transported from a water source to a well, and/or contaminated fracking water that is transported from a well to a water treatment, disposal, and/or storage facility. Likewise, a fluid source and a fluid destination may each refer to any well, stream, river, spring, storage facility, treatment facility, tank, pit, pond, and/or any other location having fluid and/or capable of receiving fluid.

Fluid source data and fluid destination data may include, as an example, a fluid volume, a fluid type, a fluid flow rate, a pick-up location identifier, a pick-up location name, geographic coordinates of a pick-up location, a pick-up time, a pick-up date, a drop-off location identifier, a drop-off location name, and/or geographic coordinates of a drop-off location. It will be appreciated that the fluid source data and/or fluid destination data may include a variety of other parameters and/or information.

The term “management computer,” as used herein, refers to any computing device capable of accessing the server computer 102 and/or the fluid management database 117. The management computer 103 may include a client device used by an individual having management access or other like credentials, as an example. In another example, the management computer 103 may be a laptop and/or personal computer used for accessing the fluid transportation management system 1000. The management computer 103 may be in communication with the server computer 102 through any number of protocols or methods, such as but not limited to an HTTP connection through a web browser installed on the management computer 103.

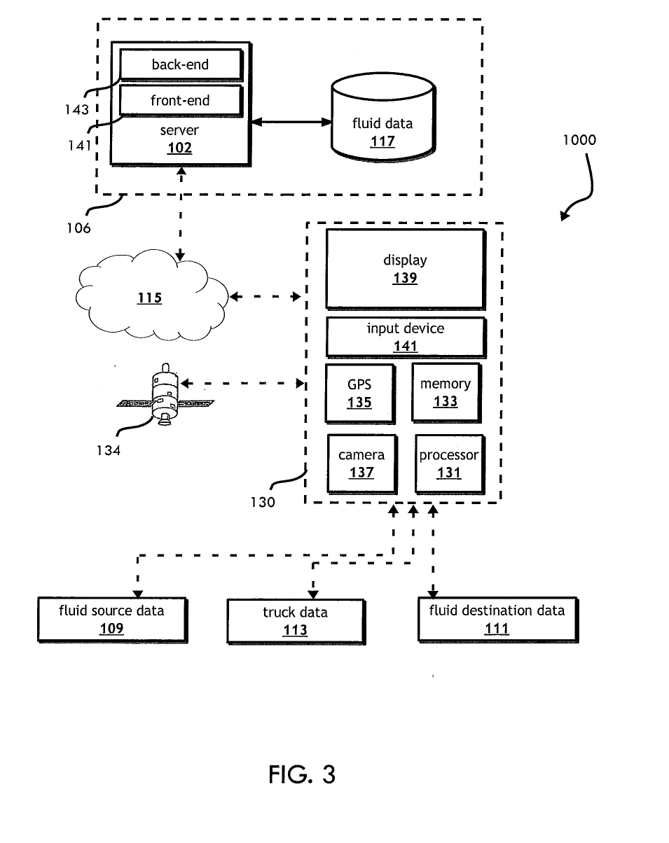

As used herein, the terms “client device” and “client devices” refer to one or more hardware and/or software components that allow for user interaction and data transmission and/or receipt. In one preferred and non-limiting embodiment, the client devices are smartphones that have processing and display capabilities, and/or software applications that can run on such devices. However, it will be appreciated that a client device may be any mobile or portable computing device, or components thereof. With reference to FIG. 3, the client device 130 may include, but is not limited to, an input device 141, a display device 139, a Global Positioning System (GPS) receiver 135, a processor 131, a memory device 133, a camera or optical sensing device 137, network functionality, and/or the like. In one preferred and non-limiting embodiment, the client device is provided with a mobile client application that may include compiled program instructions configured to perform various tasks and display various interfaces when executed. The mobile client application may also be executed by a remote computing device, such as the server computer 102, which then provides the client device with display data (such as in the form of a graphical user interface (GUI)) and receives input data from the client device.

A “fluid management database,” as used herein, may refer to one or more data structures that include fluid data, such as but not limited to fluid source data, fluid destination data, truck data, and/or flow data. The data structures may be distributed and/or centralized. For example, the fluid management database may include multiple databases at one or many locations, or may include a single database. Further, the fluid management database may be any form of data structure such as, but not limited to, delimiter-separated data, vectors, arrays, trees, tables, and/or the like.

With continued reference to FIG. 1, the client device 105 may be used to scan and/or otherwise receive fluid source data 109, truck data 113, and/or fluid destination data 111 from any number of data resources. Data resources may include, for example, visual indicia, radio frequency identification (RFID) transponders, memory devices, codes, wireless signals, data inputs, and/or the like. In one example, a data resource may be a matrix barcode or standard barcode, an RFID transponder, and/or a wireless signal. In another example, a data resource may be any type of printed or electronic data that is manually input into a client device 105, automatically input into a client device 105, or is otherwise read, scan, and/or received by the client device 105. In a further example, the data resource may be a computing device that transmits data to the client device 105 via near-field communication (NFC) methods and/or Bluetooth protocols. In yet another example, the data resource may be printed data that may be received by a client device through any number of Optical Character Recognition (OCR) processes. It will be appreciated that other variations are possible.

Still referring to FIG. 1, the client device 105 may receive the fluid source data 109 from a data resource proximate to a fluid source (e.g., pick-up location) and transmit it to the server computer 102, which then stores at least a portion of the fluid source data 109 in the fluid management database 117. At the pick-up location, or at another time, the client device 105 may receive the truck data 113 from a data resource on or otherwise associated with a truck, which is also transmitted to the server computer 102 and the fluid management database 117. After the truck is driven from the pick-up location to a drop-off location, the client device 105 receives the fluid destination data 111 and transmits the same to the server 102 and/or fluid management database 117. The management computer 103 may then request a report or other form of visualized and/or structured data that is at least partially based on the fluid source data 109, the truck data 113, and/or the fluid destination data 111. The client device 105 may also store all received fluid data and/or other information locally and synchronize with the server computer 102 when a connection is available or at predefined intervals.

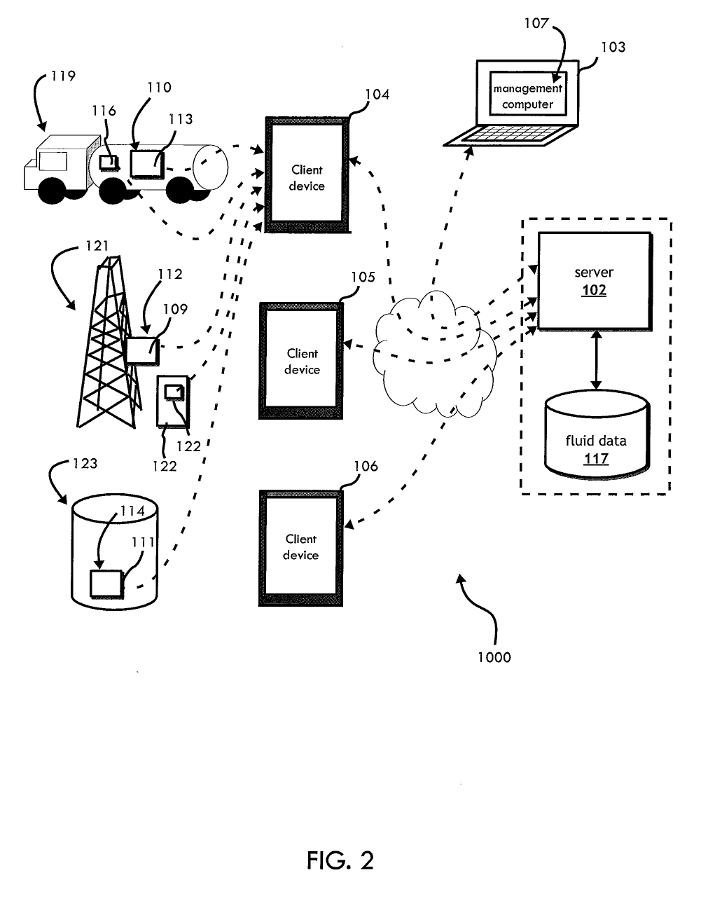

Referring now to FIG. 2, a fluid transportation management system 1000 is shown according to another preferred and non-limiting embodiment. A fluid transportation management host 106 includes a server computer 102 and a fluid management database 117. It will be appreciated that, as already explained, the fluid management database 117 may be local to the server computer 102, the client devices 104, 105, 106, and/or remotely hosted. The server computer 102 and host 106 are in communication with a management computer 103 and client devices 104, 105, 106 through a network environment 115, such as the internet, a wide-area network (WAN), or other form of communication. The client devices 104, 105, 106 are able to receive truck data 113 from a truck data resource 110, fluid source data 109 from a fluid source data resource 112, and fluid destination data 111 from a fluid destination data resource 114.

With continued reference to FIG. 2, one or more data resources 110, 112, 114 may include the truck data 113, source data 109, and/or destination data 111. In one preferred and non-limiting embodiment, the truck data resource 110, the fluid source data resource 112, and the fluid destination data resource 114. include one or more visual indicia such as, but not limited to, standard barcodes, matrix barcodes (e.g., two-dimensional barcode, QR code, etc.) and/or other visual data resources. These data resources 110, 112, 114 may be scanned, detected, or otherwise read by the client devices 104, 105, 106. In an embodiment, a camera unit of the client device 104, 105, 106 may be used to optically scan the visual data resources. However, as already explained, the data resources 110, 112, 114 may be in any number of forms.

Still referring to FIG. 2, a truck 119 includes a flow meter 116 and a truck data resource 110 that includes truck data 113. A well 121 is proximate to a fluid source data resource 112, including fluid source data 109. The well 121 is also equipped with a pumping device 124 that includes a flow meter 122, which may be in communication with the client devices 104, 105, 106. It will be appreciated that the fluid source data resource 112 may be proximate and/or associated with any fluid source such as, but not limited to, fresh water sources, wells, tanks, other trucks, and/or the like. A fluid storage tank 123 includes, or is proximate to, a fluid destination data resource 114, including destination data 111. It will be appreciated that the fluid destination data resource 114 may be associated with and/or proximate to any number of fluid destinations such as, but not limited to, tanks, wells, treatment plants, pits, disposal facilities, treatment facilities, other trucks, and/or the like. The client devices 104, 105, 106 are configured to read, scan, or otherwise receive the truck data 113, source data 109, and/or destination data 11.

Still referring to FIG. 2, in one preferred and non-limiting embodiment, one or more flow meters 116, 122 or other types of measurement equipment associated with one or more trucks, pumps, locations, and/or the like, measures the amount (e.g., volume and/or weight), pressure, and/or velocity of fluid as it is pumped into the truck 119 and/or out of the truck 119. Although FIG. 2 depicts the flow meter 116 as being part of or otherwise associated with the truck 119, it will be appreciated that measurement equipment may be associated with any number of devices at a fluid source and/or destination. The resulting flow data can be transmitted back to the host 106 to be saved and associated with location data, well data, truck data, and/or other types of fluid data. The flow data can then be used to ensure compliance with laws, regulations, and/or standards such as those established by the USGS or DEP. In one example, the flow data may be used to ensure that an amount of fresh water intake does not exceed a specified maximum amount associated with that particular water source or location.

With continued reference to FIG. 2, the flow meters 116, 122 may be configured to communicate with the client device 104 via various telemetry protocols and/or other methods. For example, the flow meters 116, 122 may transmit wireless or hardwired signals to the client device 104. In another example, the flow meters 116, 122 may have display devices that can be scanned or otherwise imaged with the client device 104. Additionally, the flow meters 116, 122 may transmit flow data to a remote source that can be subsequently accessed by the client device 104. It will be further appreciated that any number of measurement and/or monitoring devices may be used to retrieve fluid data during transfer of the fluid to and/or from the truck 119, or at any other point in the transportation process, and that many types of devices and/or methods may be used to obtain such measurements.

In one preferred and non-limiting embodiment, the client devices 104, 105, 106 are configured to receive stream gauge data. The stream gauge data may be communicated to the client device 104 via telemetry equipment configured to transmit measurements of stream-flow discharge, stream stage (e.g., elevation of water surface), and/or the like. In some examples, the stream gauge data is available to the client through an HTTP connection or other protocol. The stream gauge data may also be included in a data resource. In this way, the client device 104 may be configured to receive this existing data or otherwise access the measurement equipment at the stream gauge location. In a non-limiting embodiment, the stream gauge data may be retrieved from a central USGS data resource that is already in communication with a stream gauge station. The stream gauge data may be used to provide alerts to users if a measurement, such as a stream stage measurement, is below a specified minimum amount. Alerts may include, as examples, push messages on a client device, emails, text messages, and/or the like. As an example, the minimum stream gauge measurement may be specified by a regulatory agency, such as the DEP, when a stream withdrawal point is approved. If the stream gauge data is received by the client device 104 via an internet connection, and no connection is available at a particular time, the client device 104 and/or server computer 102 may use the latest, or last, stream gauge data from that location.

In one preferred and non-limiting embodiment, the system 1000 may also, or alternatively, track fluid that is transported through a piping network. In this example, flow meters and/or other measurement equipment may be installed throughout the piping network, or in pumps that are used to supply and/or retrieve fluid from the pimping network. As in other examples described, a client device 104 may be used to scan a data resource associated with a piping network, or otherwise receive piping network data, and provide the server computer 102 with the received data. In this way, the piping network may be viewed as a method of transportation, just like a truck, and the various functionalities described herein may be likewise realized with one or more piping networks instead of, or in combination with, one or more trucks.

With reference to FIG. 3, the server computer 102 may include a back-end component 143 and a front-end component 141, which respectively provide data management and data input services to the management computer 103 and the client device 130. The host 106, including the server computer 102 and fluid management database 117, provides services, such as the transfer, receipt, and processing of data, to the client device 130 and the management computer 103, as well as any other devices capable of receiving and/or transmitting data. The client device 130 may include various components and/or modules such as, but not limited to, a central processing unit 131, an input device 141, a display device 139, a Global Positioning System (GPS) receiver 135, a processor 131, a memory device 133, and/or a camera or optical sensing device 137. A satellite 134 is in communication with the client device 130 to provide the client device 130 with geographic coordinates.

Still referring to FIG. 3, the system 1000 allows fluid hauling expenses and hauling times to be tracked through client devices 104, 105, 106 used by truck drivers, well operators, and/or other users. In a preferred and non-limiting embodiment, the client devices 104, 105, 106 receive fluid source data at a pick-up location and fluid destination data at a drop-off location. The fluid source data and fluid destination data may include, for example, well data and/or location data. The hauling can be tracked going to and/or from a well, or other facility where the fluid is produced, obtained, and/or needed. This allows for pick-up and drop-off times, amounts of fluid hauled, types of fluid hauled, and/or other parameters to be tracked and logged by the host 106. The data received by the mobile clients 104, 105, 106 may be transmitted to the host 106, including the server computer 102 and/or database 117, which may then provide the fluid data in various configurations and arrangements for reports.

In one preferred and non-limiting embodiment, various front-end graphical user interfaces (GUIs) are provided to users. Users may be passive users, active users, administrative users, super administrative users (i.e., superadmins) and/or a combination of passive, active, and/or administrative users. In one non-limiting embodiment, active users are provided with data entry interfaces, as will be described, passive users are provided with report generation interfaces, as will also be described, and administrators may be provided with report generation interfaces and further features for viewing and/or interacting with the fluid management data. Superadmins may have extended privileges for modifying the interfaces, data types, parameters, and/or the like.

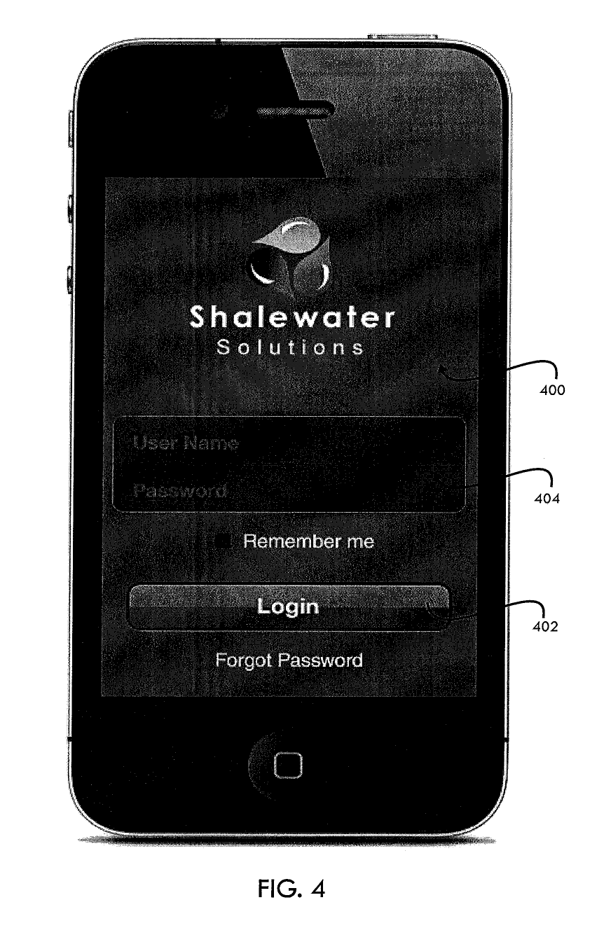

Referring to FIG. 4, a login interface 400 is shown according to one preferred and non-limiting embodiment. A user may input his or her login credentials into the credential fields 404 and select the login button 402. After pressing the login button 402, the user's credentials may be transmitted to the server computer 102, which determines the access level of the user based at least partially on the credentials. Based on the user's access level, different interfaces may be subsequently displayed on the client device.

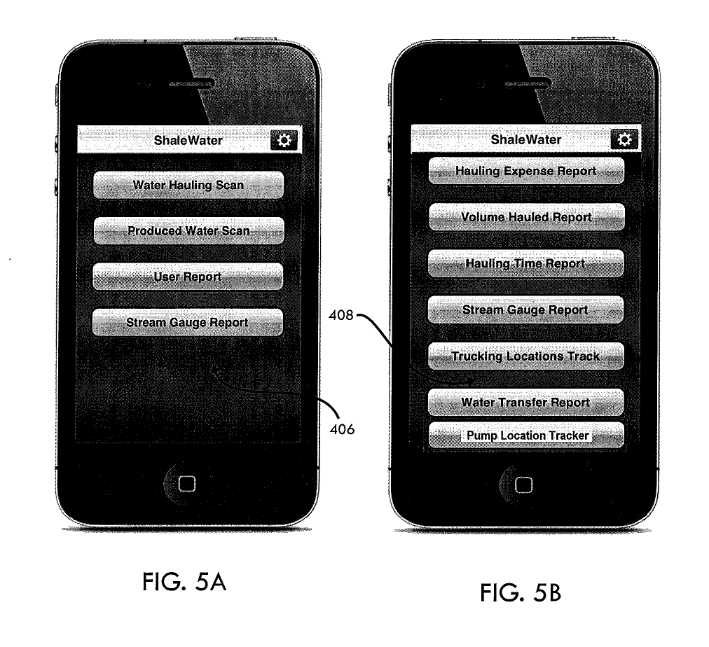

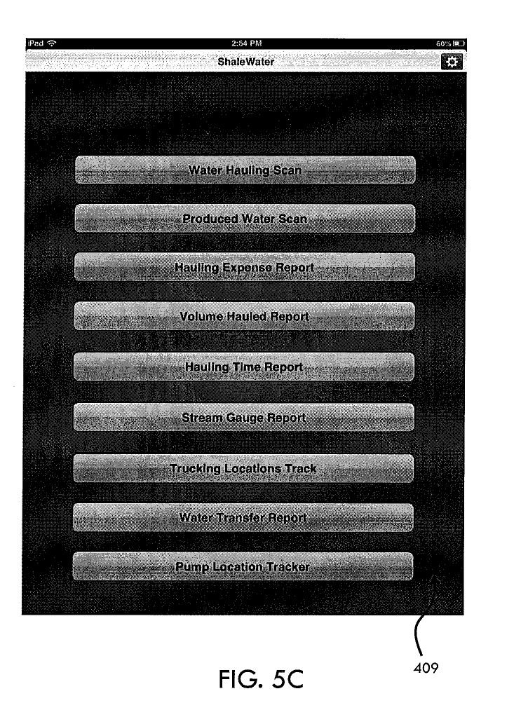

Referring to FIG. 5A, an active user menu interface 406 is shown according to one preferred and non-limiting embodiment. Several options and/or buttons may be presented, such as Water Hauling Scan, Produced Water Scan, User Report, and Stream Gauge Report. Referring now to FIG. 5B, a passive/administrative user menu interface 408 is shown according to one preferred and non-limiting embodiment. The passive/administrative user menu interface 408 may include, for example, various options and/or buttons to track fluid transportation and/or generate reports. In the embodiment shown in FIG. 5B, the buttons include Hauling Expense Report, Volume Hauled Report, Hauling Time Report, Stream Gauge Report, Trucking Locations Track, Water Transfer Report, and Pump Location Tracker. It will be appreciated that a variety of different menu interfaces may be provided and that, in some embodiments, there may not necessarily be any menu interfaces. Referring to FIG. 5C, an administrative user menu interface 409 is shown according to one non-limiting embodiment. As can be seen, the administrative user menu interface 409 includes the report generation options and other features shown in FIGS. 5A and 5B.

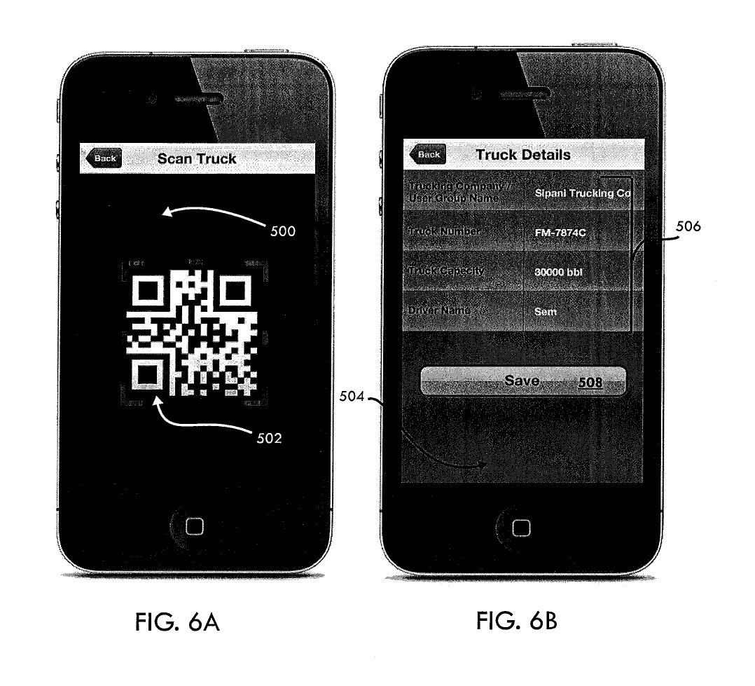

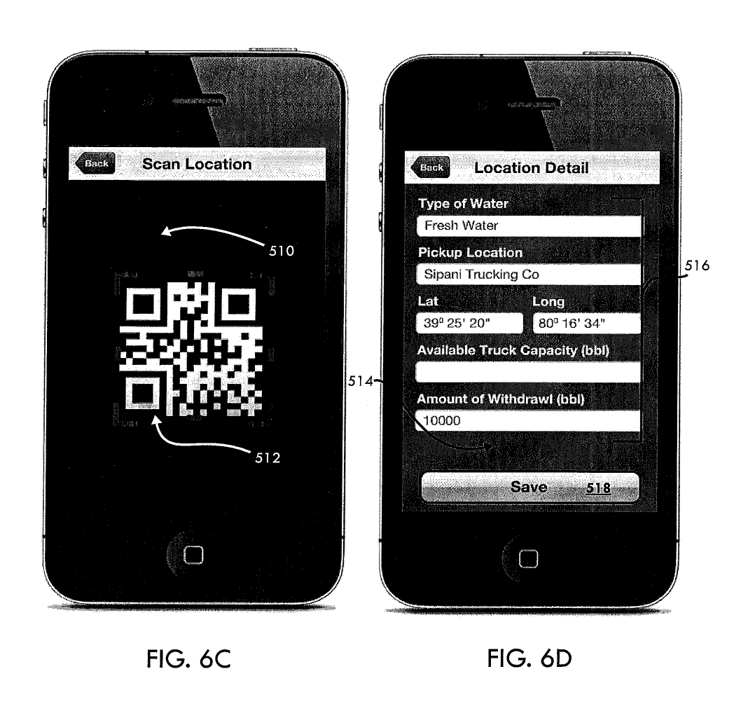

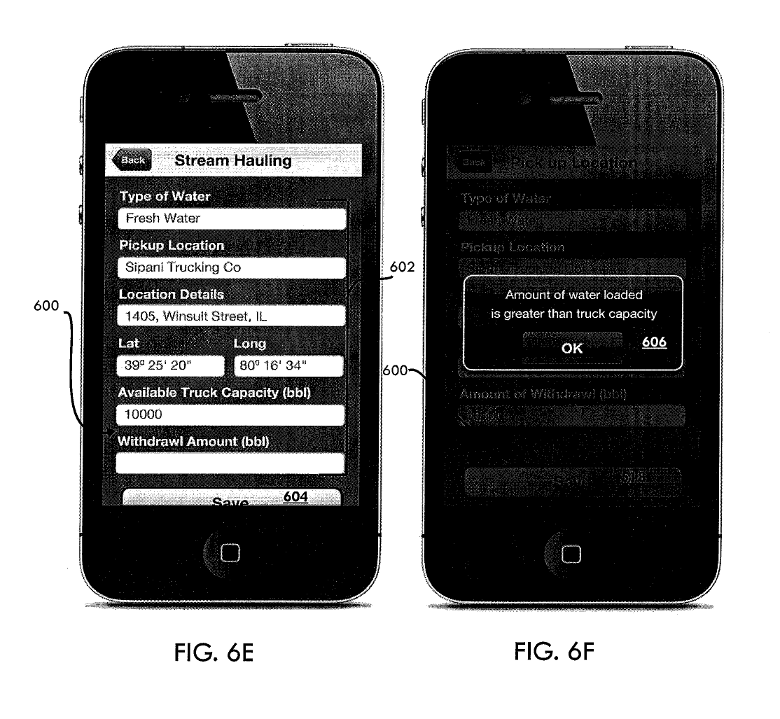

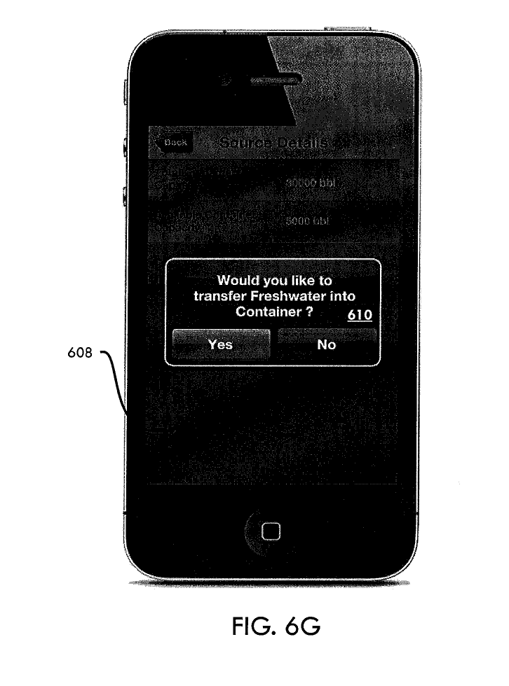

With continued reference to FIG. 5A, if the user selects the Produced Water button, the interfaces shown in FIGS. 6A-6F may be provided and there may be multiple pick-up locations that each involve receiving data from a data resource. In such a scenario, multiple withdrawals by one truck can be performed and each withdrawal tallied to track the total volume being added to the truck. If the Water Hauling button is selected, there may be only one location scan. However, it will be appreciated that the interfaces may be presented in any number of formats and/or sequences. Moreover, if the user selects the User Report button, that user may be able to generate and/or view a report regarding the loads hauled by that user or by the truck used by that user. If the user selects the Stream Gauge Report button, the user may be able to generate and/or view a report regarding one or more stream gauges.

Referring now to FIGS. 6A-6F, if an active user selects Water Hauling and/or Produced Water from the active user menu interface 406, the user may be presented with interfaces configured to allow the user's client device to receive and/or retrieve fluid data, including truck data and fluid source data. If a user selects Water Transfer, the user may be presented with interfaces configured to allow the user's client device to receive and/or retrieve fluid data, including truck data and fluid destination data. Further, if a user selects Produced Water, the user may be presented with interfaces configured to allow the user's client device to receive and/or retrieve fluid source data from multiple fluid sources, and/or truck data. For example, and with reference to FIGS. 6A and 6B, after selecting an option on the active user menu interface 406, the user may be prompted to scan a truck data resource 502 on a scan truck interface 500. After scanning the truck data resource 502, a truck details interface 504 may be presented that includes a truck data display 506 and a save button 508 to confirm the truck data that is displayed. The truck data display 506 may include, for example, a trucking company or user group name, a truck number, a truck capacity, a driver name, and/or other like information.

With reference to FIGS. 6B-6D, after selecting the save button 508, a scan location interface 510 may be displayed, prompting the user to scan a location data resource 512 which may include, for example, a fluid source data resource and/or a fluid destination data resource. After scanning the location data resource 512, a location details interface 514 may be displayed that includes a location data display 516 for various parameters such as, but not limited to, a type of water at that location, a name of the pick-up location, geographic coordinates (e.g., longitude and latitude) for the location, an available truck capacity (which may, in one example, be populated from the truck data received), and an amount of withdrawal. In one example, the amount of withdrawal may be received from one or more flow meters or other telemetry equipment associated with a stream gauge, pump, pipe network, and/or the like. In another example, the amount may be manually entered into the client device. After selecting the save button 518, the location data may be transmitted to the server computer 102 or stored locally on the device until it can be transmitted.

Referring now to FIGS. 6E and 6F, an embodiment of a location interface 600 may include location data fields 602 that may be edited by a user through the client device or an input device in communication with the client device. In this example, the available truck capacity may be obtained from an earlier scan of a truck data resource from the scan truck interface 500, manually inputted, or otherwise received. An alert 606 or warning may be provided to the user if there are errors in the data, or conflicting data. For example, in FIGS. 6E and 6F, the truck capacity is 10,000 bbl (barrels). If a withdrawal amount of 10,000 bbl or more is entered into the location interface 600, an alert 606 may be displayed.

Referring now to FIG. 6G, a pick-up confirmation interface 608 allows a user to confirm the fluid source information at a pick-up location. In this example, the total hauling capacity is 30,000 bbl, with 5,000 bbl of available capacity. A confirmation dialog 610 may be displayed for the user to verify that a particular type of fluid is being transferred into the container. In the confirmation dialog 610 displayed in FIG. 6G, a user is asked to confirm whether freshwater will be transferred into the container.

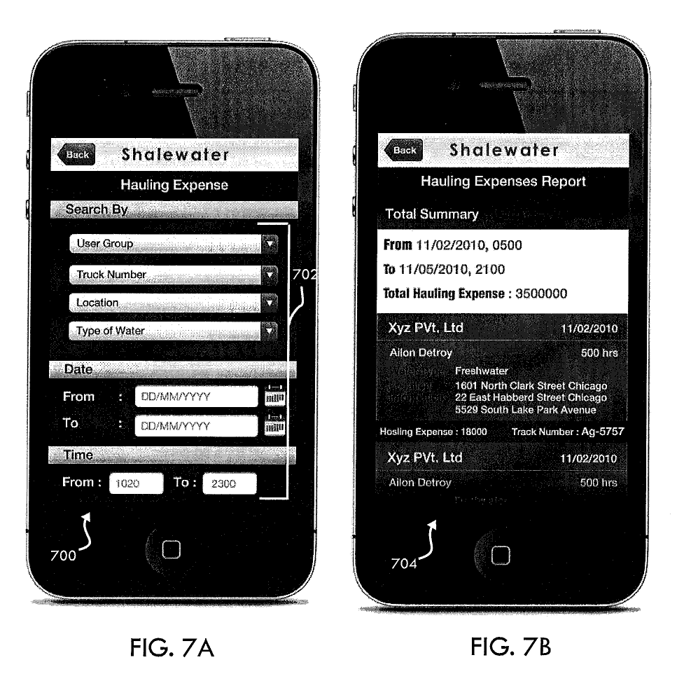

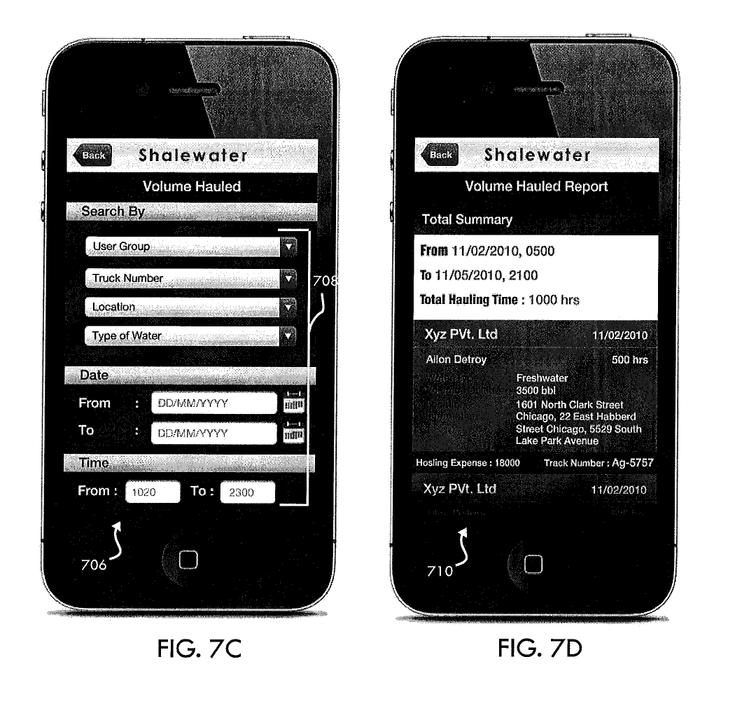

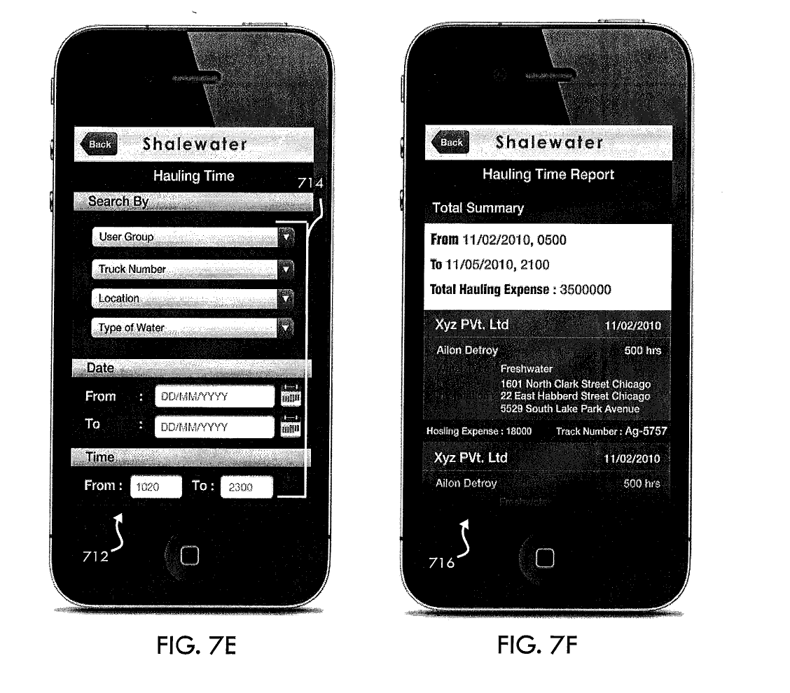

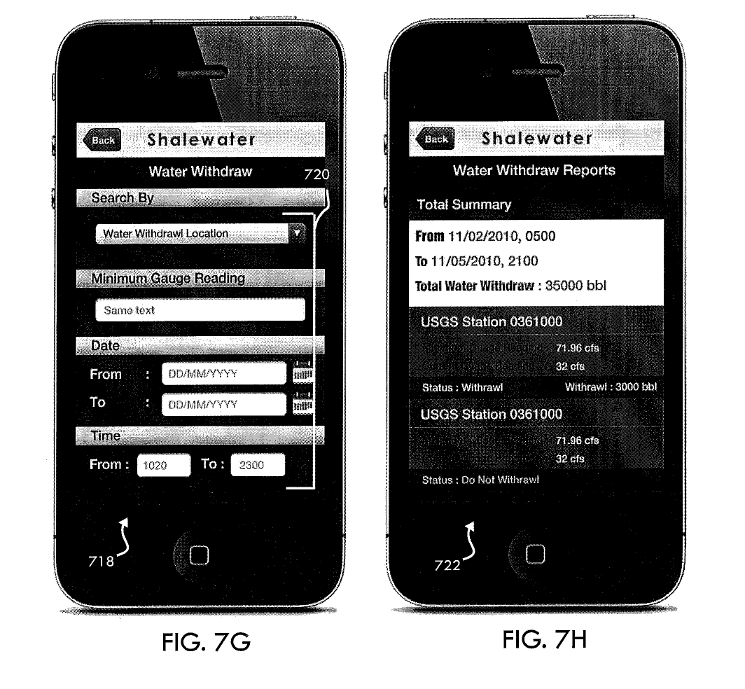

Referring now to FIGS. 7A-7H, various reporting interfaces are shown according to preferred and non-limiting embodiments. With reference to FIG. 7A, a hauling expense report generating interface 700 includes a number of hauling expense report parameters 702. The report parameters 702 may include input fields such as drop-down boxes, radio buttons, checkboxes, text boxes, and/or the like. The report parameters may include options to search and/or generate reports for fluid data by user group, truck number, location, type of fluid, and/or the like. A date and/or time range may also be selected through the hauling expense report parameters 702. Referring now to FIG. 7B, a hauling expenses report 704 is shown according to one preferred and non-limiting embodiment. In this example, a report is generated for fluid data from 5:00 on Nov. 2, 2012 to 21:00 on Nov. 5, 2012. As can be seen, the aggregated expenses in that range total $3,500,000. Each individual entry may be listed on the report 704.

Referring now to FIG. 7C, a volume hauled report generating interface 706 is shown according to one embodiment. Volume hauled report parameters 708 may include input fields such as drop-down boxes, radio buttons, checkboxes, text boxes, and/or the like. The report parameters may include options to search fluid data and/or generate a report by user group, truck number, location, type of fluid, and/or the like. A date and/or time range may also be selected through the volume hauled report parameters 702. With reference to FIG. 7D, a volume hauled report 710 is shown according to one embodiment. In one embodiment, the volume hauled report 710 may show a user the volume of fluid hauled of a certain type, by a certain trucking company, over a specified date and/or time range, and/or the like.

Referring now to FIG. 7E, a hauling time report generating interface 712 is shown according to one embodiment. Hauling time report parameters 714 may include input fields such as drop-down boxes, radio buttons, checkboxes, text boxes, and/or the like. The hauling time report parameters 714 may include options to search fluid data and/or generate a report by user group, truck number, location, type of fluid, and/or the like. A date and/or time range may also be selected through the report parameters 714. With reference to FIG. 7F, a hauling time report 716 is shown according to one embodiment. In one embodiment, the hauling time report 716 may show a user the volume of fluid hauled of a certain type, by a certain trucking company, over a specified date and/or time range, and/or the like.

Referring now to FIG. 7G, a withdrawn water report generating interface 718 is shown according to one embodiment. Water withdrawn report parameters 720 may include input fields such as drop-down boxes, radio buttons, checkboxes, text boxes, and/or the like. The water withdrawn report parameters 720 may include options to search fluid data and/or generate a report by user group, truck number, location, type of fluid, and/or the like. A date and/or time range may also be selected through the water withdrawn report parameters 720. With reference to FIG. 7H, a water withdraw report 722 is shown according to one embodiment. The water withdraw report 722 may show a user the volume of fluid withdrawn from various fluid sources over a date and/or time range. The water withdraw report 722 may include a list of water sources along with a minimum gauge reading, a current gauge reading, a volume withdrawn for each location, and/or the like.

It will be appreciated that various other interfaces may be provided to generate reports. For example, a user report generating interface may include options to search fluid data and/or generate a report by user group, truck number, and/or the like. A user report, in one example, may be accessible to end-users (i.e., active users) so that they may monitor their activities, progress, and various jobs. Numerous other report generating interfaces are possible, and such report generating interfaces may be accessible by administrative users, active users, and/or passive users.

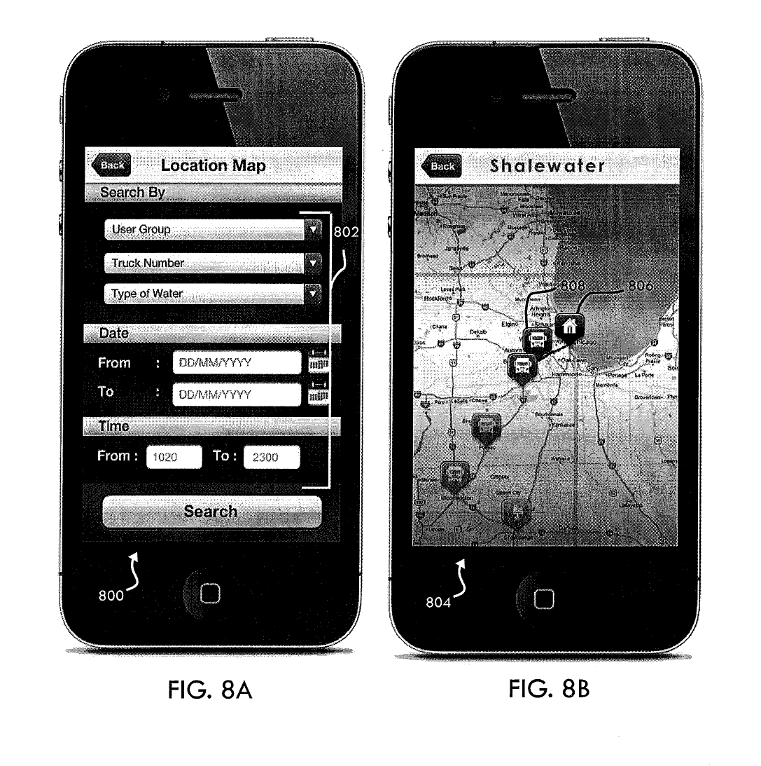

Referring now to FIG. 8A, a location map search interface 800 is shown according to one embodiment. The location map search interface 800 has a number of search parameters 802 for searching by user group, truck number, type of fluid, date range, time range, and/or the like. Selecting a search button may present the map interface 804 shown in FIG. 8B. The map interface 804 includes a number of icons 806, 808 to identify locations, wells, trucks, and/or the like. In one example, the locations shown may include the location of every pick-up, drop-off, and/or truck scan. Further, in one embodiment, the truck icon 808 may represent a location that a truck was last scanned, or a current truck location via real-time GPS location. It will be appreciated that the map interface 800 may be generated from various data sources such as, but not limited to, Google Maps, MapQuest, government databases, and/or the like. The map interface 800 may include a two-dimensional rendering, a satellite image, and/or other graphics depicting an area.

With continued reference to FIGS. 8A and 8B, in one preferred and non-limiting embodiment the map interface 804 may be generated and used to track pump locations, truck locations, and/or other locations, and the location map search interface 800 may be displayed in response to a user choosing the Trucking Locations Track button depicted in FIGS. 5B and 5C, the Pump Location Tracker button depicted in FIGS. 5B and 5C, and/or other like options. It will be appreciated that a separate map interface 804 may be provided for truck locations, pump locations, or other location features, or that a combined map interface 804 may be used. Further, it will be appreciated that a map interface 804 may be generated without having to interact with a location map search interface 800, as a user may already have specified parameters (e.g., trucking company, time/date range, etc.).

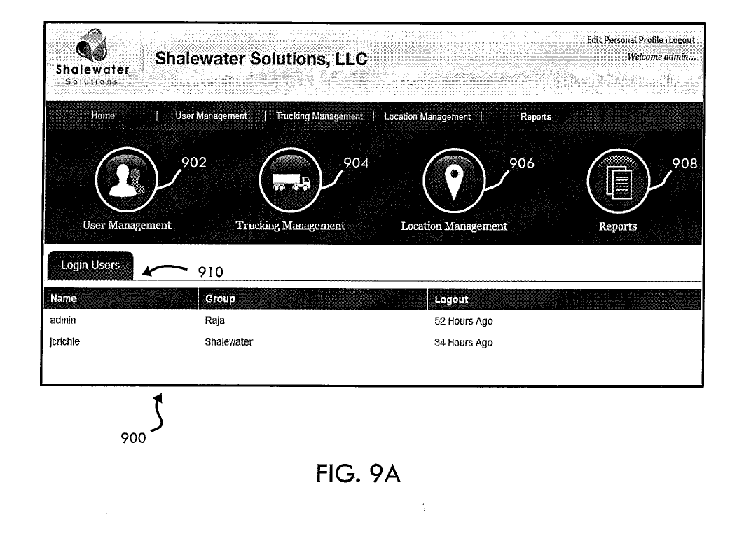

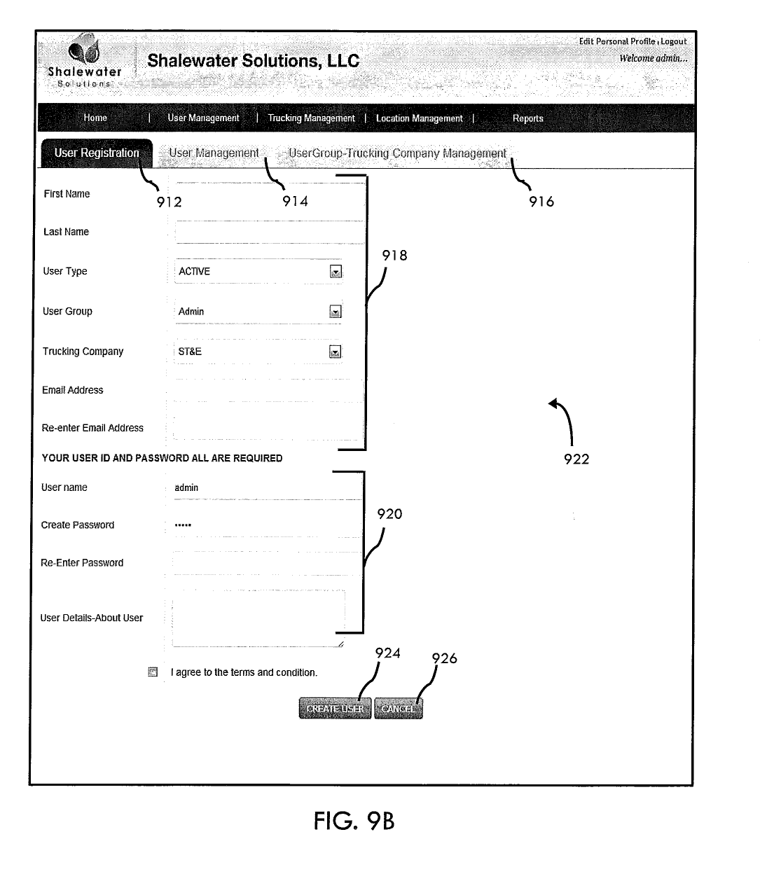

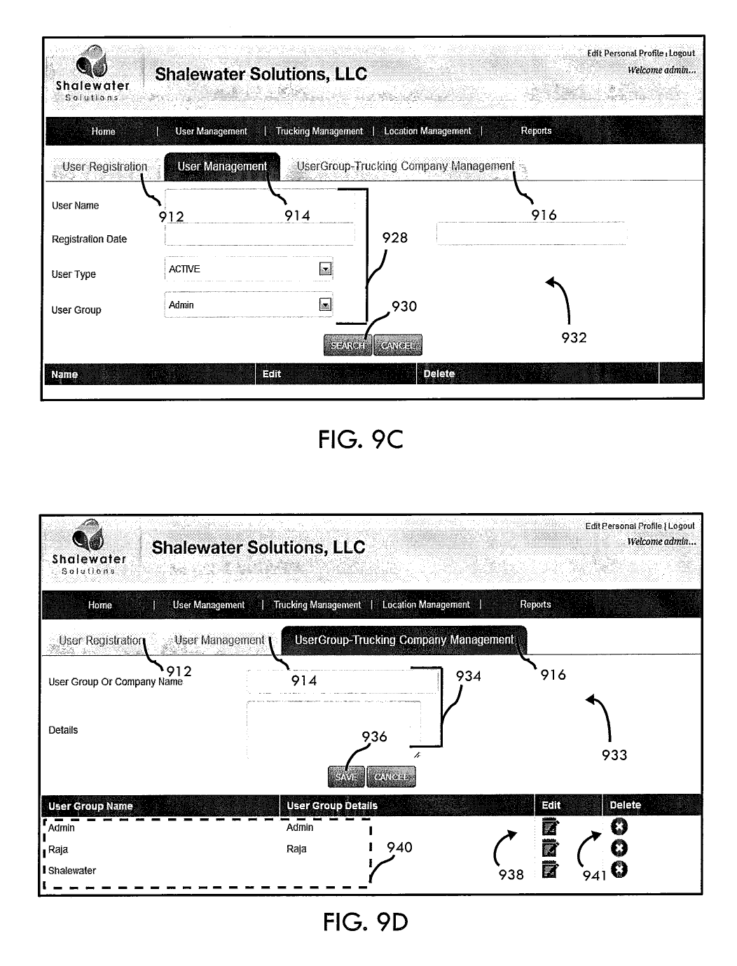

In one preferred and non-limiting embodiment, the back-end component 143 provides user computers, such as but not limited to the management computer 103, with one or more graphical user interfaces (GUI), including the management GUI 107. With reference to FIGS. 9A-12E, a series of management GUIs are shown. FIG. 9A depicts a management menu interface 900 that includes a user management option 902, a trucking management option 904, a location management option 909, and a report option 908. The management menu interface 900 may further include a user list 910 of previous users that logged into the management interface 107. In some examples, the management menu interface 900 is displayed to a user after the user provides login information such as, but not limited to, a login name and/or password.

With reference to FIGS. 9A-9D, if a user selects the user management option 902 on the management menu interface 900, a user management interface 922 may be displayed. The user management interface 922 may include one or more options for various further interfaces that are related to user management. For example, with reference to FIGS. 9B-9D, a user registration tab 912, a user management tab 914, and a user/group/trucking company management tab 916 are provided, and each may link to various interfaces.

Referring now to FIG. 9B, the user registration tab 912 displays a user registration interface 922 for creating new users for the system, including a series of user info illation fields 918 such as, but not limited to, a user's first name, last name, a user type (e.g., active, passive, administrative, superadmin, etc.), a user group, a related trucking company name, and a user email address. It will be appreciated that the user information fields 918 may further include a registration and/or expiration date for a new user. The user registration interface 922 further includes credential fields 920 for authenticating a user with administrative rights to create a new user in the system. Selecting a create user button 924 saves the data entered into the user information fields 918 and associates that data with a new user. The cancel button 926 exits the user registration interface 922 and/or clears the user information fields 918.

Referring now to FIG. 9C, a user management search interface 932 is shown according to one preferred and non-limiting embodiment. The user management search interface 932 includes search parameter fields 928 such as, for example, user name, registration date, user type, user group, and/or the like. The search parameter fields 928 may include input fields such as drop-down boxes, radio buttons, checkboxes, text boxes, and/or the like. A Search button 930 searches the saved user data for users matching one or more of the specified search parameter fields 928. With reference to FIG. 9D, a user group/trucking company management interface 933 is shown according to one preferred and non-limiting embodiment. User group and/or trucking company fields 934 may include, for example, a name of a user group and/or trucking company, and details or notes for that group or company. A save button 939 saves the data inputted into the user group/trucking company management interface 933. The interface 933 may also include a list 940 of user group names and user group details that have been previously input and saved, as well as edit options 938 and delete options 941 for each entry.

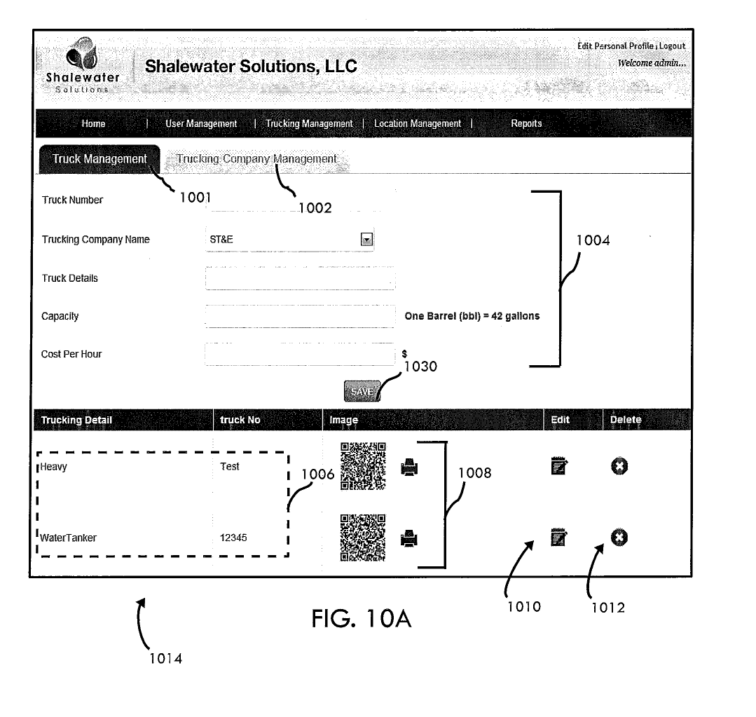

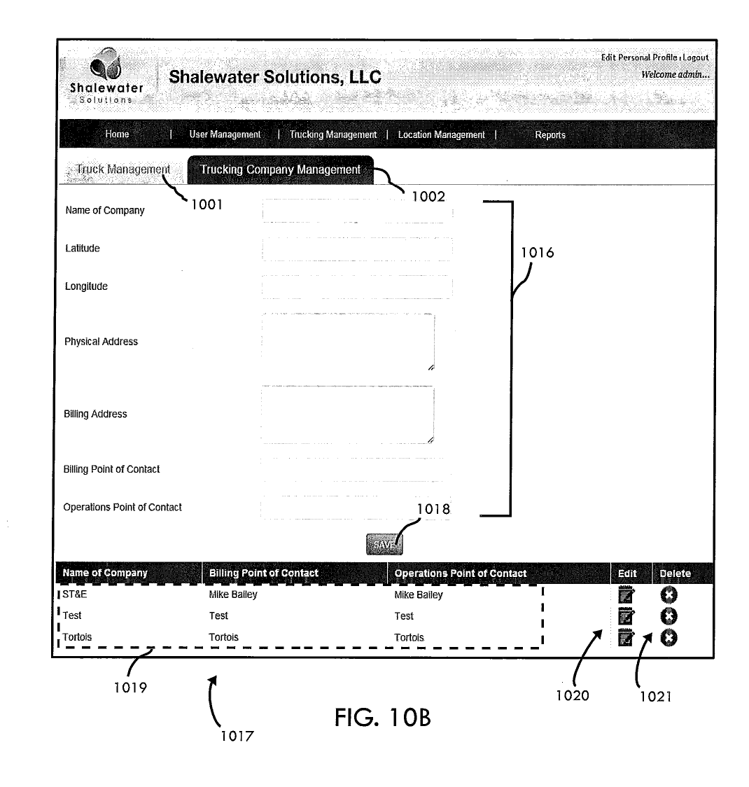

Referring now to FIGS. 10A and 10B, trucking management interfaces 1014, 1017 are shown according to a preferred and non-limiting embodiment. A truck management tab 1001 and a trucking company management tab 1002 are associated with the truck management interface 1014 and trucking company management interface 1017, respectively. With reference to FIG. 10A, the truck management interface 1014 includes a plurality of truck data fields 1004 such as, but not limited to, truck number, trucking company name, truck details, capacity, cost per unit of time, and/or the like. The data fields 1004 may include input fields such as drop-down boxes, radio buttons, checkboxes, text boxes, and/or the like. A save button 1001 saves the information in the truck data fields 1004 as a record or entry. Below the data fields 1014, the records 1006 may be displayed including, for example, the truck numbers and/or details. Each entry may be associated with a data resource, such as visual indicia 1008 (e.g., a matrix barcode, standard barcode, etc.), and an option to print the visual indicia 1008. The visual indicia 1008 includes truck data for each field, such as but not limited to the information identified by the truck data fields 1014, and/or an identifier to locate such information. Edit options 1010 for each record allow a user to edit the truck data, and delete options 1012 for each record allow for a record to be cleared from memory. The visual indicia 1008 may be uniquely generated for the inputted truck data fields 1004, and printed for use in the field.

Referring now to FIG. 10B, a trucking company management interface 1017 is shown according to one preferred and non-limiting embodiment. Truck company data fields 1016 may include, for example, the name of a company, geographic coordinates (e.g., longitude and latitude), a physical address, a billing address, a billing point of contact, and/or an operations point of contact. A save button 1018 may save the information input into the trucking company data fields 1016 as a new record or entry. The trucking company management interface 1017 may further include a display of the records, with edit options 1020 and delete options 1021 for respectively editing the trucking company data and/or truck data, and deleting the same.

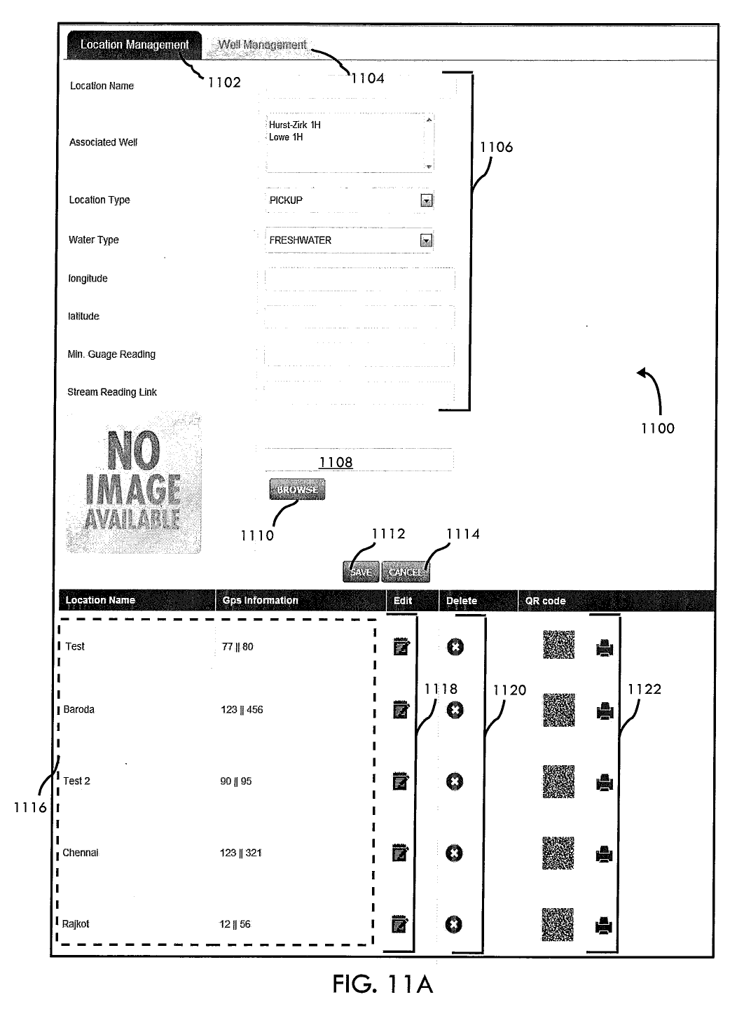

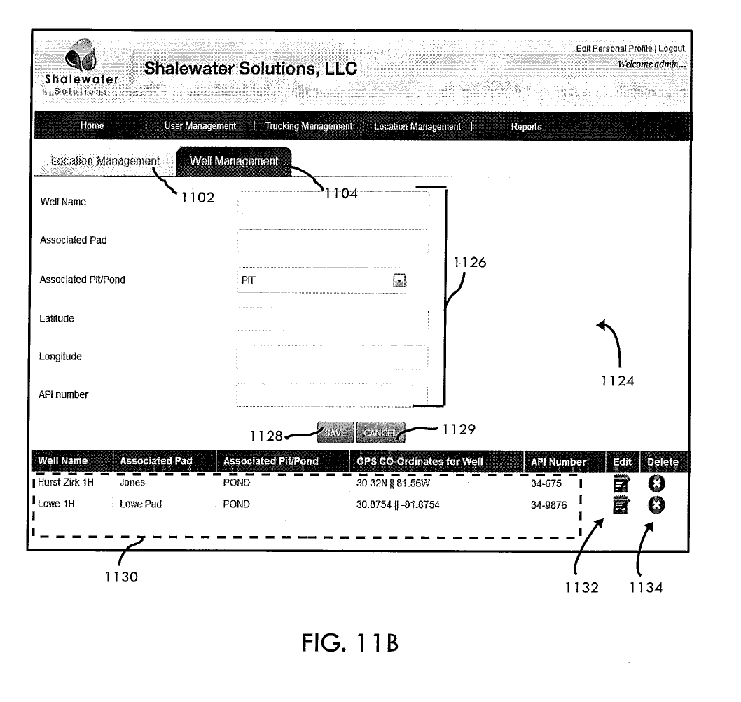

Referring now to FIG. 11A, a location management interface 1100 is shown according to one preferred and non-limiting embodiment. A location management tab 1102 and a well management tab 1104 may be displayed to alternately display the location management interface 1100 and well management interface 1124 shown in FIG. 11B. The location management interface 1100 includes a plurality of location data fields 1106 including, for example, location name, wells associated with a location, location type, water type, geographic coordinates (e.g., longitude and latitude), minimum gauge reading, stream reading link (e.g., a link or pointer to the data received from a flow meter associated with a location), and/or the like. An image path field 1108 and associated browse button 1110 allow a user to search and/or browse for images of the location to save and associate with the location data in the location data fields 1106. The location type data field may include various options such as, for example, pick-up, drop-off, pick-up and drop-off, well site, truck yard, and/or the like. The associated wells field may include options that include a list of wells retrieved from well data, and a “not applicable” option for locations that have no associated wells. In some instances, multiple wells may be selected for each location. The location management interface 1100 may further include a display of location data records 1116, each record associated with visual indicia 1122 that include at least some of the location data for the associated record. Edit options 1118 and delete options 1120 for each record allow a user to edit and/or delete records or entries of location data.

Referring to FIG. 11B, a well management interface 1124 is shown according to one preferred and non-limiting embodiment. Well data fields 1126 may include, for example, a well name, a pad associated with a well, a pit and/or pond associated with a well, geographic coordinates (e.g., latitude and longitude), and/or an API number. An API number refers to an identifier assigned to oil and gas wells by the American Petroleum Institute. In some circumstances, it may be necessary to distinguish between wells and associated well pads because wells are often named after the owner of the mineral rights, and pads are often named after the owner of the surface rights. It will be appreciated that other identifiers, standardized or otherwise, may also be used. A save button 1128 and cancel button 1129 respectively save a data record with data input into the data fields 1126 and deletes or clears the same from memory. In one example, a pit and/or pond data field include options to specify pit, pond, or none. The well management interface may 1124 may further display records of well data 1130, edit options 1132 for editing a record of well data, and delete options 1134 for deleting a record of well data.

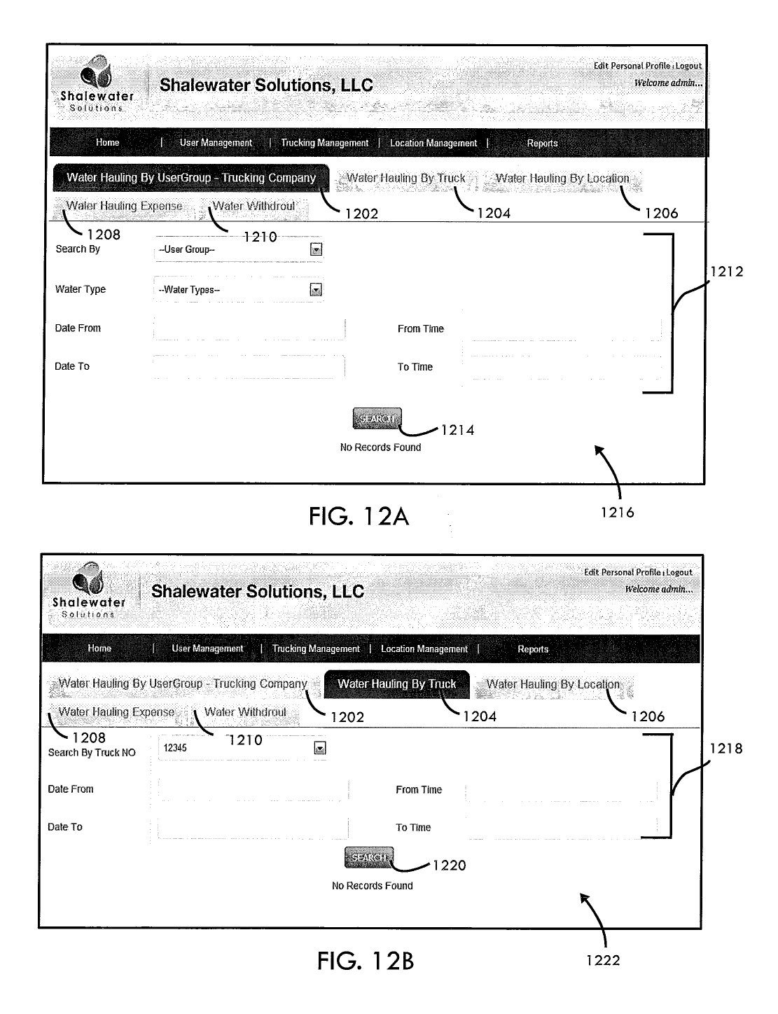

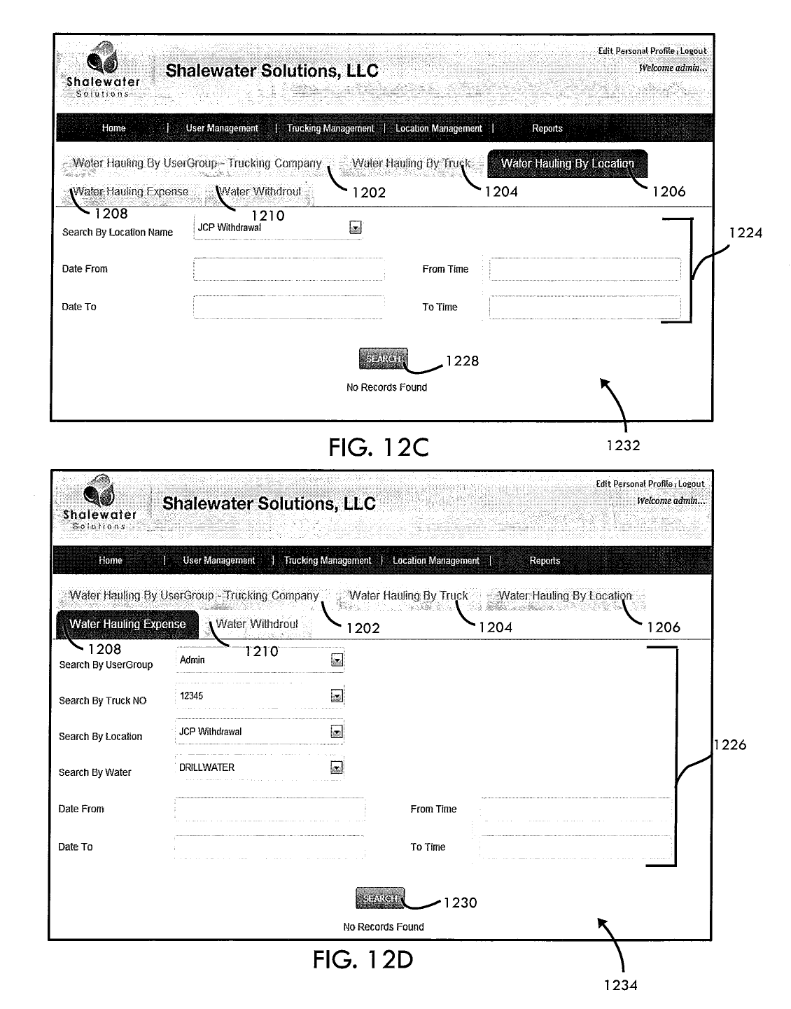

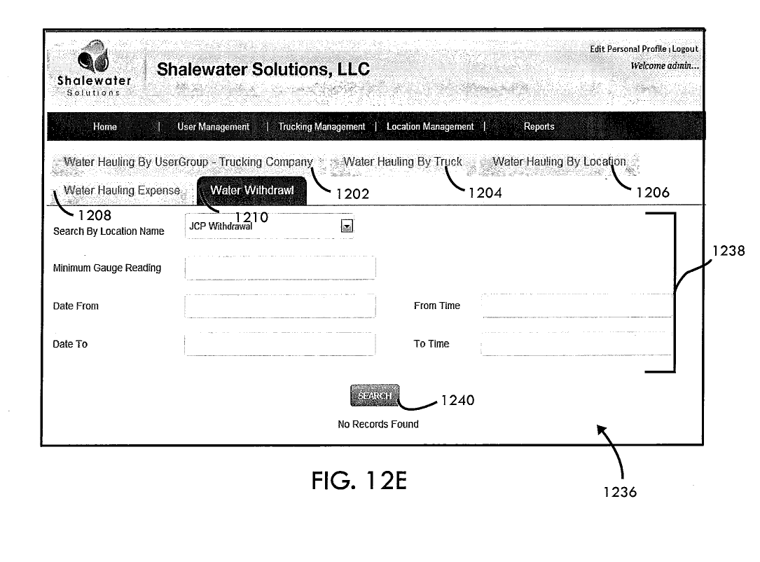

Referring now to FIGS. 12A-12E, a plurality of management report generation interfaces are shown according to one preferred and non-limiting embodiment. The management report generation interfaces may be provided with multiple tabs or other selection options that allow a user to select among a variety of report generation options and interfaces. A Water Hauling By User Group/Trucking Company tab 1202, a Water Hauling By Truck tab 1204, a Water Hauling By Location tab 1206, a Water Hauling Expense tab 1208, and a Water Withdrawal tab 1210 may be displayed in an upper region of each report generation interface, as an example. It will be appreciated that the report generation interfaces may be browsed and/or selected by a user in any number of ways, and that the report generation interfaces may vary in number and type.

Referring now to FIG. 12A, a water hauling by user group/trucking company report generation interface 1216 is shown according to one preferred and non-limiting embodiment. A variety of search parameters 1212 are provided. The search parameters may include input fields such as drop-down boxes, radio buttons, checkboxes, text boxes, and/or the like. A Search button 1214 may be used to search for fluid data matching one or all of the search parameters 1212, and provide the user with a report based on the parameters 1212.

Referring to FIG. 12B, a water hauling by truck report generation interface 1222 is shown according to one preferred and non-limiting embodiment. A variety of search parameters 1218 are provided and may include input fields such as drop-down boxes, radio buttons, checkboxes, text boxes, and/or the like. A search button 1220 may be used to search for fluid data matching one or all of the search parameters 1218 in order to provide a user with a report.

Referring now to FIG. 12C, a water hauling by location report generation interface 1232 is shown according to one preferred and non-limiting embodiment. As in the other report generation interfaces, a variety of search parameters 1224 are provided, including a location name and a date and/or time range. The search parameters may include input fields such as drop-down boxes, radio buttons, checkboxes, text boxes, and/or the like. A search button 1228 may be used to search for fluid data matching one or all of the search parameters 1224, and provide the user with a report generated based on those parameters 1224.

With reference to FIG. 12D, a water hauling expense report generation interface 1234 is shown according to one preferred and non-limiting embodiment. The search parameters 1226 may include, for instance, options to search by user group, truck number/identifier, location, water type, date range, and/or time range. A search button 1230 may be used to search for fluid data matching one or all of the search parameters 1226, and may generate a report based on those parameters 1226.

Referring now to FIG. 12E, a water withdraw report generation interface 1236 includes a variety of search parameters 1238, allowing a search to be defined by location name, minimum gauge reading, a date range, and/or a time range. A search button 1240 may be used to commence the search and report generation. It will be appreciated that, in FIGS. 12A-12E, the reports may be generated in any number of ways. For example, reports may be generated and displayed based on static, predefined parameters, and/or dynamic parameters. In another example, previously generated reports may be stored, accessed, and/or modified. Various other implementations are possible. Certain reports may include volume by drop-off location or pick-up location, total volume hauled by trucking company, total volume hauled by a particular truck, total trucking expense, total time hauled by trucking company or particular truck, and/or the like.

In one non-limiting embodiment, data resources may also be supplied for various pumps, tanks, and other equipment to allow the use and location of such equipment to be tracked and logged. For example, individuals removing equipment from a site may scan the equipment and/or a location data resource to provide a record, through the server computer, of where the equipment is being used or was transported to.

In one preferred and non-limiting embodiment, a settings interface may be provided on a client device 104 to allow a user to adjust various settings such as, but not limited to, accessibility, synchronization, and/or the like. Although the fluid data may be transmitted from the client device 104 to the server computer 102 and/or the fluid management database 117 automatically, upon receiving the fluid data or at specified intervals, a synchronization option may also be provided to allow users to transmit fluid data if the data is initially received offline, or in a region without sufficient network communication. Moreover, in some embodiments, the client device 104 may be further configured to check for network connectivity at intervals and, when it is determined that communication is possible, transmit the fluid data to the server computer 102 and/or the fluid management database 117. It will be appreciated that various other arrangements and/or sequences may be utilized to transmit the fluid data from the client device 104 to the server computer 102.

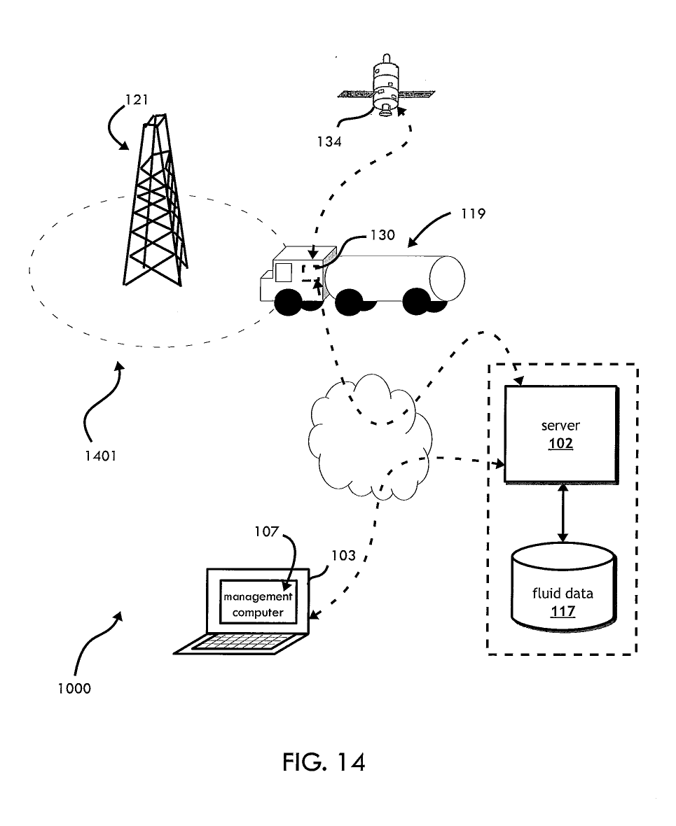

In a preferred and non-limiting embodiment, and with reference to FIG. 14, a fluid transportation management system 1000 includes a fluid transportation management host 106, including a server computer 102 and a fluid management database 117. A truck 119 is driven by a driver in possession of a client device 130 that is in communication with the server 102 and GPS satellite 134 or other like positioning system. Accordingly, as the driver moves the truck 119, the physical location (e.g., geographic coordinates) of the client device 130 can be transmitted to the server 102 for processing. A well 121 is within a geographic boundary 1401 (e.g., geofence) that is defined by a set of coordinates and/or a radius from a single point. A management computer 103 is also in communication with the server 102, and includes one or more GUIs 107 to track and/or manage the fluid data.

With continued reference to FIG. 14, the client device 130 and/or server computer 102 may be adapted, programmed, and/or configured to detect when the physical location of the truck 119 is within the boundary 1401. In this manner, a driver of the truck 119 may not have to interact with the client device 130 to indicate that a destination has been reached. Through the use of the boundary 1401 and positioning systems, the system 1000 can automatically determine when the truck 119 is making a pick-up or drop-off, and log the activity accordingly in the fluid management database 117. It will be appreciated that the boundary 1401 may be defined by the management computer 103 and/or by other entities. In some non-limiting examples, the boundary 1401 may not surround the well 121 or other location but, instead, exist as one or more points along a road or other ingress/egress locations. The boundary 1401 may also be implemented through radio frequency identification, physical triggers or switches on an access road, and/or the like. In a preferred and non-limiting embodiment, the boundary 1401 is defined by a location, a radius, and a type.

In a preferred and non-limiting embodiment, and with continued reference to FIG. 14, the waypoint of a truck 119 is recorded while the truck is traveling to or from a destination. The waypoint may include, for example, the latitude, longitude, altitude, horizontal accuracy, vertical accuracy, speed, and/or direction (e.g., degrees from North) for a given point in time along the truck 119 route. The waypoint may be measured by the client device 130 in the truck 119, using sensors on or in communication with the client device 130 such as, for example, GPS receivers, accelerometers, gyroscopes, compasses, and/or the like. However, it will be appreciated that various other sensors may also be used, and that the sensors may be part of the client device 130, the truck 119, or any other device.

In a preferred and non-limiting embodiment, and with continued reference to FIG. 14, the client device 130 will be paired to a truck 119 (e.g., associated with the truck in a database), and that client device 130 will record and/or relay information regarding the route of that truck 119. Each route for the truck 119 may be defined by an origin and a destination location, corresponding to the pick-up and drop-off locations for the contents of the truck 119. While traveling a route, a client device 130 may record and/or transmit waypoints to the server 102, allowing for back-end management of the trucking logs. The waypoints may be recorded and/or transmitted periodically or at predetermined locations. The origin and destination locations are recorded and/or transmitted based on the truck 119 entering or exiting the boundary 1401.

In a preferred and non-limiting embodiment, the system is configured to operate when network connectivity is unavailable or variable. The data communicated between the server 102 and client device may be minimized and restricted to only necessary information. Further, if a network connection is unavailable, the client device 130 is configured to store the outgoing data locally and to periodically attempt to retransmit it to the server 102. When a connection becomes available, the client device 130 may transmit the stored data and receive incoming data from the server 102. The incoming data from the server 102 may be stored locally on the client device 130 in case the network connection is subsequently lost. Since location data is generally available from a GPS satellite 134, the loss of a network connection should not affect the determination of a location.

In a preferred and non-limiting embodiment, the client device 130 may include a microphone and a speaker. The client device 130 may also be in communication with a stereo system or speaker in the truck 119. It will be appreciated that any of the text appearing on a GUI of the client device 130, in addition to other information, may be audibly annunciated through the speaker of the client device 130 or the truck 119. Further, any user selection, option, or command may be input through spoken words or phrases received by a microphone of the client device 130 and processed by the client device 130 and/or the server 102. In some non-limiting embodiments, the client device 130 may be programmed, configured, and/or adapted to limit or prevent user interaction at various stages or with certain GUIs to eliminate user error.

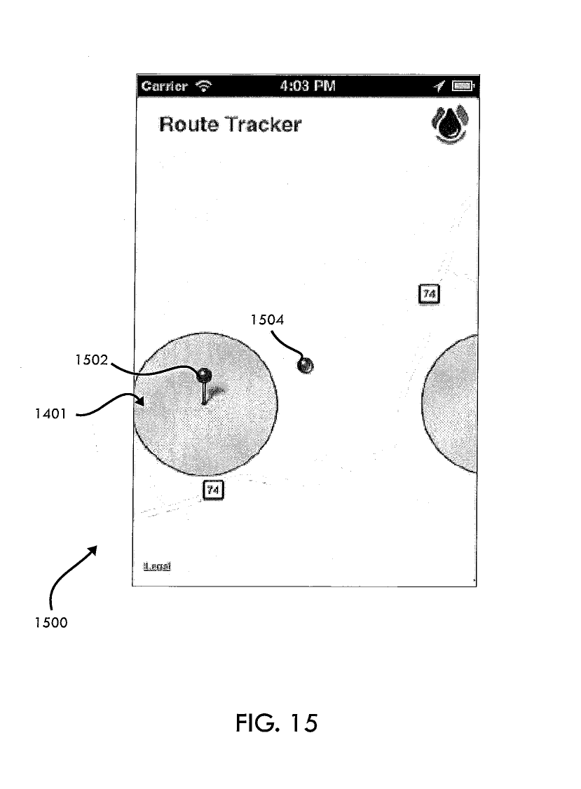

Referring now to FIG. 15, a route tracking GUI 1500 is shown according to a preferred and non-limiting embodiment. The route tracking GUI 1500 may be displayed on a client device and include a visual representation of a boundary 1401 surrounding a particular site or location 1502. A marker 1504 represents a current location of the truck 119 in relation to the location 1502 and/or boundary 1401. The route tracking GUI 1500 allows for a driver to easily understand and interpret the information that is being conveyed. For example, icons and audible sounds are used for alerts, indications, markers, and/or the like, so that drivers do not need to take their eyes off of the road and so that illiterate drivers are able to understand important information.

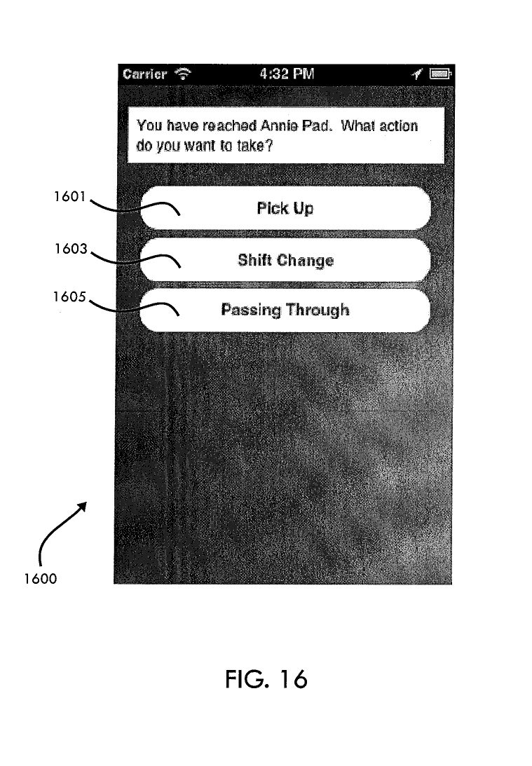

Referring now to FIG. 16, an action GUI 1600 is shown according to a preferred and non-limiting embodiment. The action GUI 1600 may be automatically presented on the client device 130 when a truck 119 enters a boundary 1401 without having previously picked up any fluid. The text appearing on the action GUI 1600 may be annunciated by a text-to-speech service, and prompts the driver to indicate the action that they are taking at the entered site. For example, a driver may choose a “pick up” button or option 1601, a “shift change” button or option 1603, a “passing through” button or option 1605, or any other desired, determined, or configurable action or event that is or will be associated with the entered site. Upon selection of an action, the client device 130 may highlight the button or option and annunciate the text to the user. A “confirmation” button or option may also appear on the action GUI 1600, allowing the driver to confirm the selection made. Once the action is confirmed, the client device 130 may then display the route tracking GUI 1500 shown in FIG. 15.

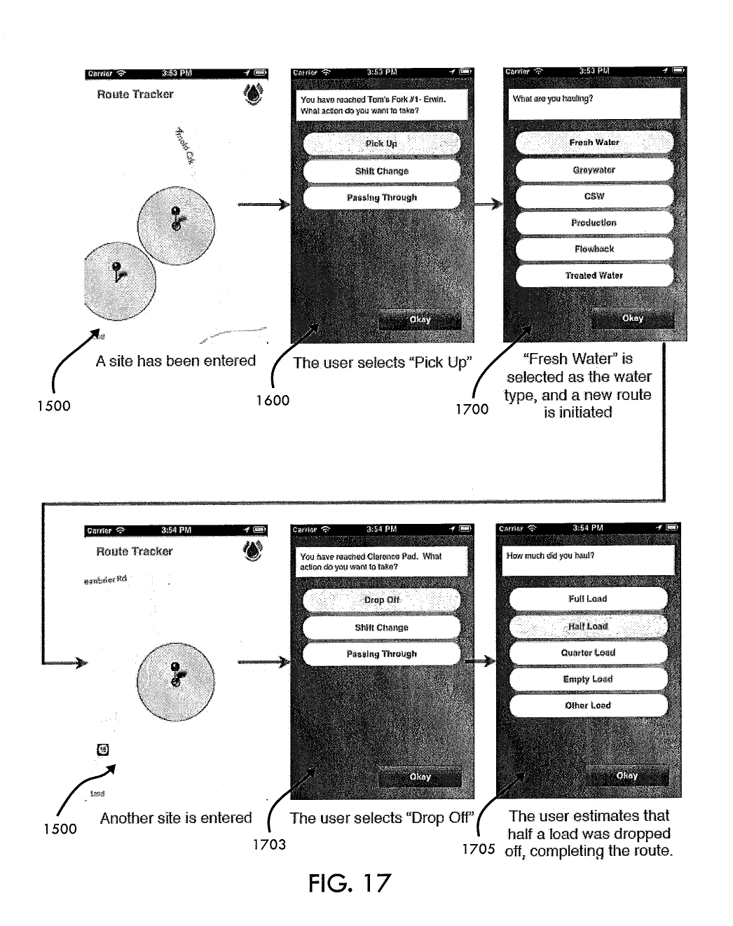

With reference to FIGS. 16 and 17, selection of the “pick up” button or option 1601 may cause a further GUI 1700 to be displayed that prompts the user to select the type of fluid being picked up. This water selection GUI 1700 may be similar to the action GUI 1600 in that the types of fluid are presented as selectable options or buttons, and the instructions are audibly annunciated for the driver. The selection of the “pick up” button or option 160 also initiates a “pick up” mode so that, when a different boundary 1401 is subsequently entered, a “drop off” button or option is displayed in place of the “pick up” button or option 1601. After selecting the “pick up” button or option 1601 and a fluid type, the client device 130 and/or server 102 may create a new route and begin recording and/or transmitting data related to the movement of the truck 119. Once the “pick up” mode is initiated, selection of the “shift change” button or option 1603 or the “passing through” button or option 1605 may record or transmit data relating to that selection, but will not end the route. The route will be ended once a “drop off” button or option is eventually selected.

With continued reference to FIGS. 16 and 17, after the “pick up” mode is initiated and the truck 119 begins its route, the route tracking GUI 1500 is displayed until a second boundary 1401 is entered by the truck 119. As the client device 130 may be in a “pick up” mode, therefore indicating that the truck 119 is hauling fluid, the action GUI 1703 displayed may include a “drop off” option or button. Upon selection of the “drop off” option or button, the driver may be prompted to enter the amount of fluid that is being or was dropped off at the drop-off location. Again, instructions may be audibly annunciated to the driver, and selection or input of a drop-off amount may cause the client device to annunciate the selection or input and prompt the user to confirm the drop-off amount. Upon confirmation, the route is indicated to be complete and the client device sends any data recorded during the route to the server 102 that has not already been communicated.

Referring now to FIG. 17, a sequence of GUIs is shown according to a preferred and non-limiting embodiment. As already described, the route tracking GUI 1500 leads to the action GUI 1600 in which a “pick up” option or button is provided. Once the “pick up” option or button is selected to indicate a fluid pick-up, a fluid selection GUI 1700 is presented and a fluid type is selected or inputted. Once the fluid type being picked up is selected, the route tracking GUI 1500 is displayed again until the truck 119 enters into another boundary. Once the second boundary is entered, a next action GUI 1703 is displayed. Upon selecting a “drop off” option or button, a user is brought to a drop off GUI 1705 in which the amount of fluid being dropped off is selected or inputted.

One possible type of drop-off location is a water treatment facility or other like fluid processing facility. Typically, paper manifests are used at these locations to record information regarding the fluid drop-off, and to acknowledge delivery of the same. In a preferred and non-limiting embodiment, client devices used at these facilities may be programmed, configured, and/or adapted to provide an electronic manifest. For example, a mobile client device, such as a tablet computer or smart phone, may be provided with a mobile manifest application that executes locally and/or remotely. The client device running the mobile manifest application may be in communication with a server, allowing interaction with the fluid management database. Since the environmental conditions in which the client device is used may be unsuitable for a computing device, the client device may be protected by a case, screen protector, and/or the like.

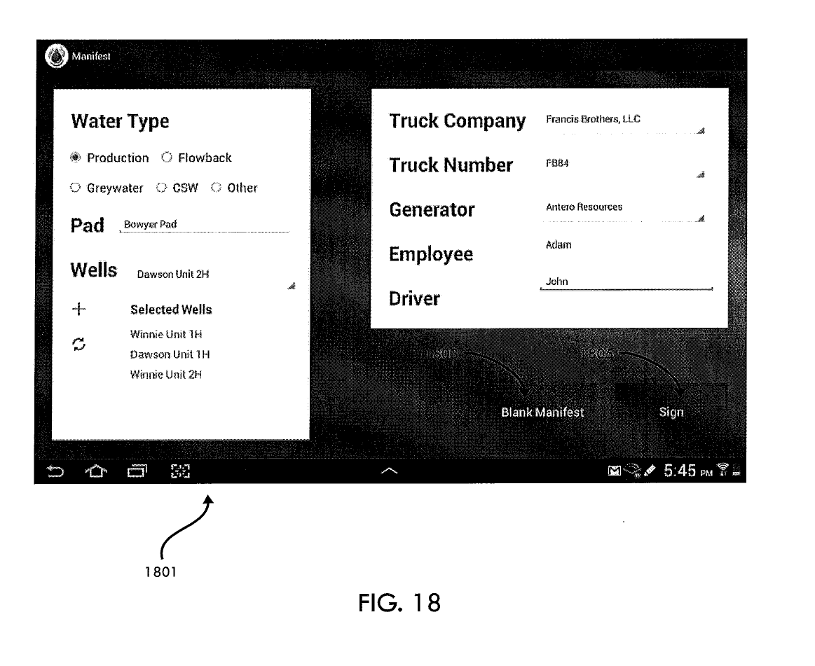

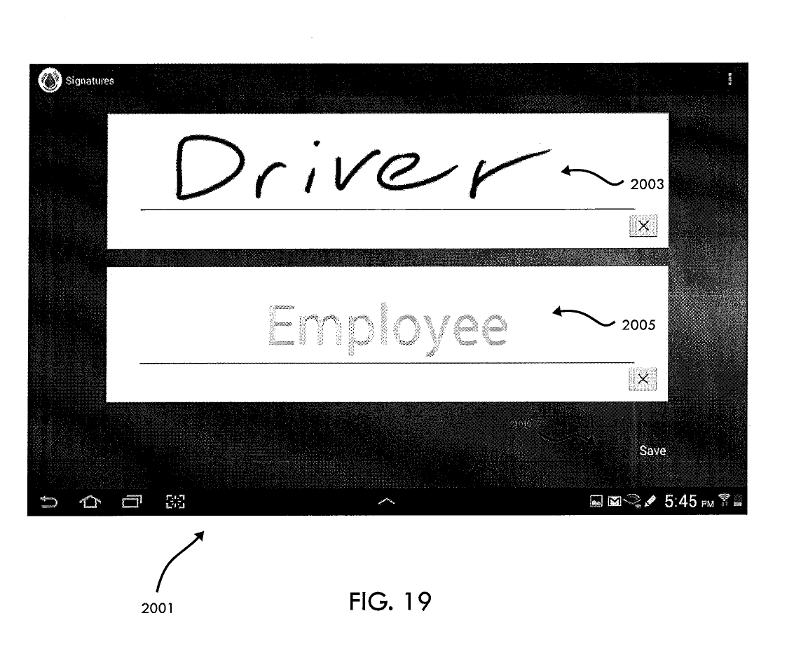

Referring now to FIG. 18, a manifest data entry GUI 1801 of a mobile manifest application is shown according to a preferred and non-limiting embodiment. A user of the GUI 1801 may select or input a fluid type (e.g., production, flowback, greywater, CSW, or other), a pad (e.g., a location that the fluid came from), and one or more specific wells from which the fluid came from. It is envisioned that the manifest data entry GUI 1801 may display or obtain any data for use in populating or generating the manifest. Still further, the fields on the manifest data entry GUI 1801 may be configured or user-configurable to allow the GUI 1801 to be modified for any specific transportation operation or application. For example, other selectable or editable options may specify a truck company, a truck number, a generator, an employee, and a driver. It will be appreciated that the data entered into the GUI 1801 may be inputted via text input fields, radio buttons, checkboxes, drop-down menus, and/or the like. Some or all of the data may also be automatically populated by the server 102 based on an identification of the truck or driver, an expected arrival time, and the like. The GUI 1801 may also include a “blank manifest” button or option 1803, and a “sign” button or option 1805. Selection of the “blank manifest” button or option 1803 may clear the data fields and users selections or inputs on the GUI 1801, and selection of the “sign” button or option 1805 may present the signature GUI 2001 shown in FIG. 19.

Referring now to FIG. 19, a signature GUI 2001 is shown according to a preferred and non-limiting embodiment. The signature GUI 2001 may be displayed in response to a user selecting the “sign” button or option 1805 on the data entry GUI 1801 shown in FIG. 18. A field 2003 for a driver's signature and a field 2005 for an employee's or verifier's signature is provided, along with a save button or option 2007. A stylus may be used by the driver and/or employee to sign the respective fields 2003, 2005, although a finger or other instrument may also be used for the signature. Once the manifest is signed, the save button or option 2007 initiates the creation of a record locally and/or remotely on the server 102. If a network connection is unavailable, the manifest data may be saved as a record locally until a network is available. The manifest data, once transmitted to the server 102, may be stored in the fluid management database 117 in relation to a fluid source, trucking company, driver, pad, and/or the like. It will be appreciated that a separate database may also be used to store the manifest data. In another preferred and non-limiting embodiment, the verification process may be automated, such that the driver's signature entered into field 2003 is compared to an existing and previously-obtained driver's signature. This verification process may occur locally on the client device or remotely through communication with a server or the like.

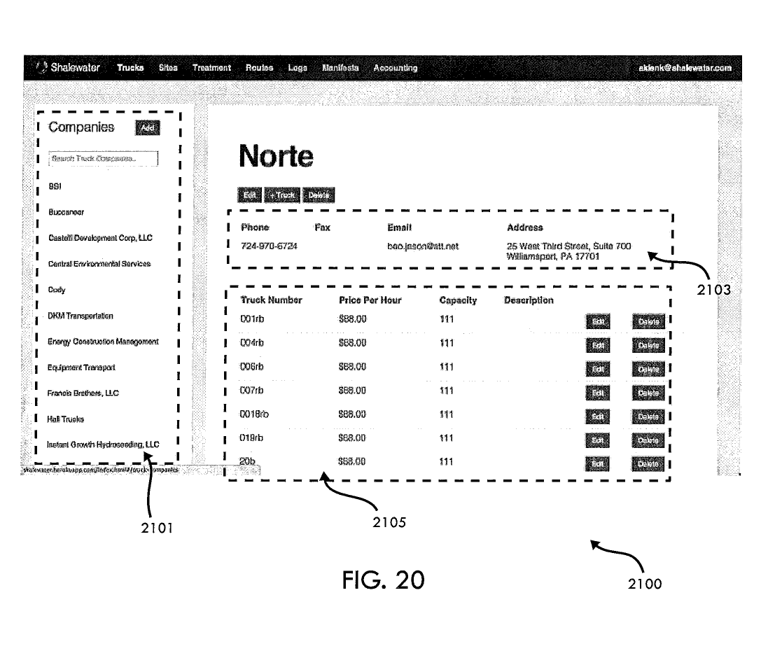

In a preferred and non-limiting embodiment, and as described herein with regard to FIG. 3, the server computer 102 may include a back-end component 143 that communicates with the management computer 103. The back-end component 143 may include, for example, a web interface configured to provide one or more web pages and/or other media content to a management or administrative user. Some examples of such interfaces, e.g., management GUIs, are shown in FIGS. 9A-12E. Further non-limiting embodiments of management GUIs are shown in FIGS. 20-25.

Referring now to FIG. 20, a truck management GUI 2100 is shown according to a preferred and non-limiting embodiment. A list 2101 of truck companies may include selectable text or options so that a user can view data related to a particular trucking company. A search box may facilitate a textual search of the companies, and an option may be available to add or import additional companies. Truck company information 2103 may be displayed on the GUI 2100, including a phone and/or fax number, an email address, an address, and any other information desired. Selectable options may allow a user to edit this information, delete the trucking company from the list 2101, or add a truck, as examples. Truck data 2105 for the selected trucking company may be listed in a tabular format, although various other display arrangements are possible. The truck data 2105 may include, for example, a truck number, a cost (e.g., price per hour), a capacity, and a description. Selectable options may also be provided to edit and/or delete a given entry.

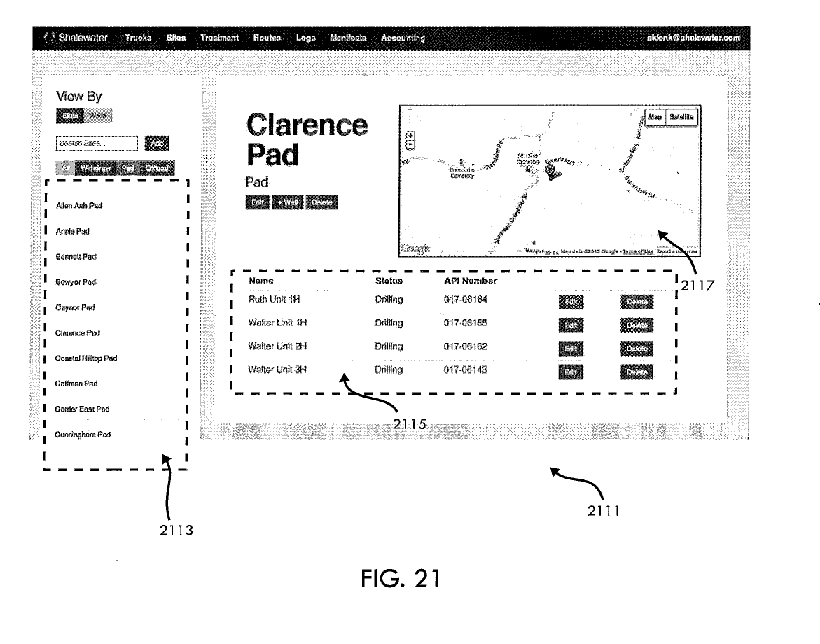

Referring now to FIG. 21, a site management GUI 2111 is shown according to a preferred and non-limiting embodiment. The site management GUI 2111 includes a list 2113 of sites, such as pads, withdrawal sites, or other types of sites or locations. A search box may facilitate a textual search of the sites, and an option may be available to add or import additional sites. The sites may be viewed by type (e.g., pad, withdrawal, offload, etc.), or may be viewed by well name rather than site name. A map interface 2117 illustrates a map image, satellite image, or other like image depicting the selected site. Selectable options may allow a user to edit and/or delete information relating to the selected site, and to add an additional well (or other type of site-related structure) to a site. For example, in addition to adding wells to a site, a user may be enabled to change the location of the well, change the name of the well, add a water source, add a drop-off facility, and/or the like.

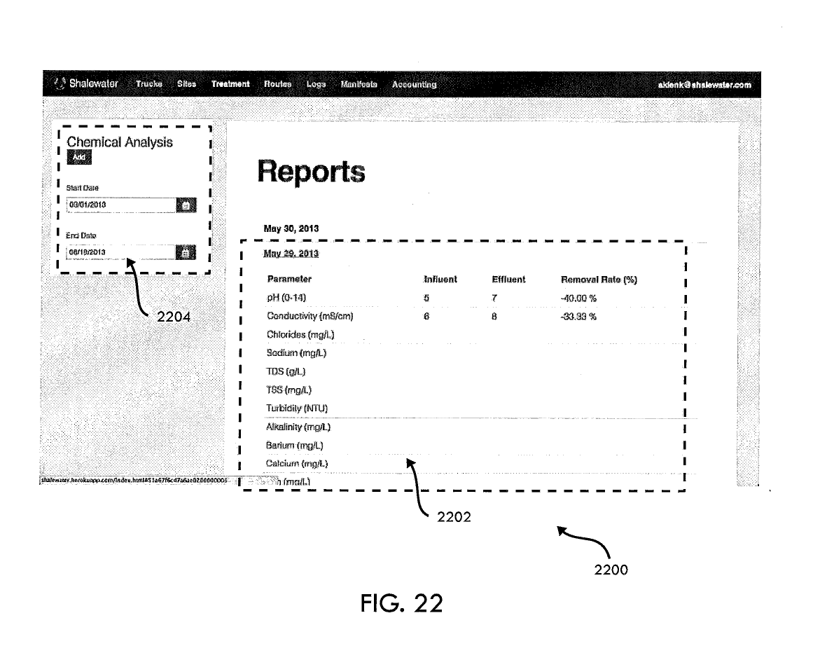

Referring now to FIG. 22, a report GUI 2200 is shown according to a preferred and non-limiting embodiment. The report GUI 2200 may be configured to allow reports 2202 to be uploaded, exported, and viewed. In some examples, the reports may concern a treatment facility and include water quality metrics such as, but not limited to, pH and turbidity. Report data may include metrics for influent and effluent, as well as a removal (e.g., effective treatment) rate or percentage. Graphs, charts, tables, and/or other visualizations may be generated to enable viewing and/or interaction with the data. The report 2202 shown in FIG. 22 includes parameters for pH, conductivity, chlorides, sodium, TSD, TSS, turbidity, alkalinity, barium, and calcium. It will be appreciated that different and/or additional parameters may be used, and that the report GUI 2200 may provide selectable options to customize, format, print, and/or export the data in a specified way. Report generation tools 2204 may include, for example, a start date parameter, an end data parameter, selectable options to choose a date from a calendar pop-up window, and selectable options to add, delete, and/or generate a report with specified parameters. The report 2202 may then be generated for the time period specified by the user with the report generation tools 2204.

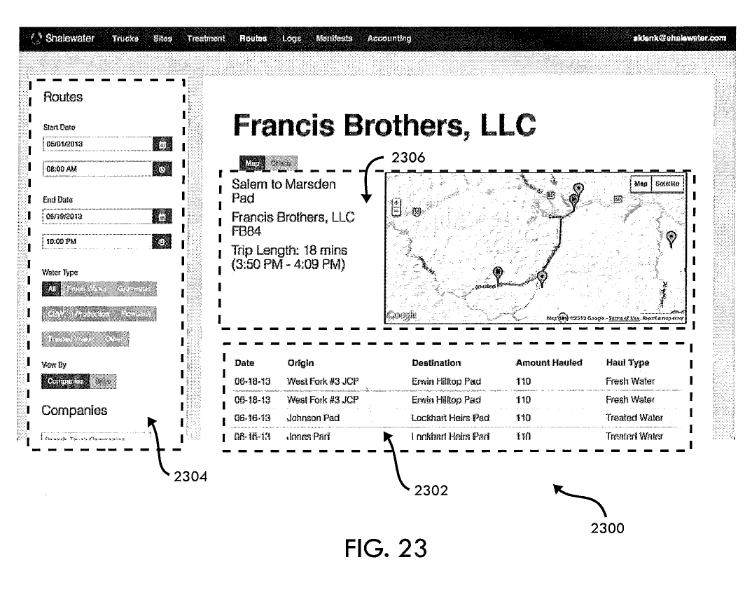

Referring now to FIG. 23, a route GUI 2300 is shown according to a preferred and non-limiting embodiment. The route GUI 2300 may be configured to display the complete routes (e.g., pick-up and drop-off sequences) for a specified time period. The route details 2302 may be displayed in tabular form and include, for each route, a data, an origin, a destination, an amount of fluid hauled, and a type of fluid hauled. However, it will be appreciated that various formats and parameters may be used to display the route details 2302. Route view options 2304 include a number of selectable options configured to control the route details 2302 that are displayed. For example, the routes may be filtered by fluid type (e.g., all, fresh water, grey water, CSW, production, flowback, treated water, other, etc.), by company, by site and/or well, and by a starting date and/or time and an ending date and/or time. The route view options 2304 may also include selectable options for a user to search routes by company name and/or site name, as examples. Route information 2306 may be displayed for a selected route from the route details, including a map or chart of the selected route. The map and/or chart may display waypoint information in addition to the starting and ending locations.

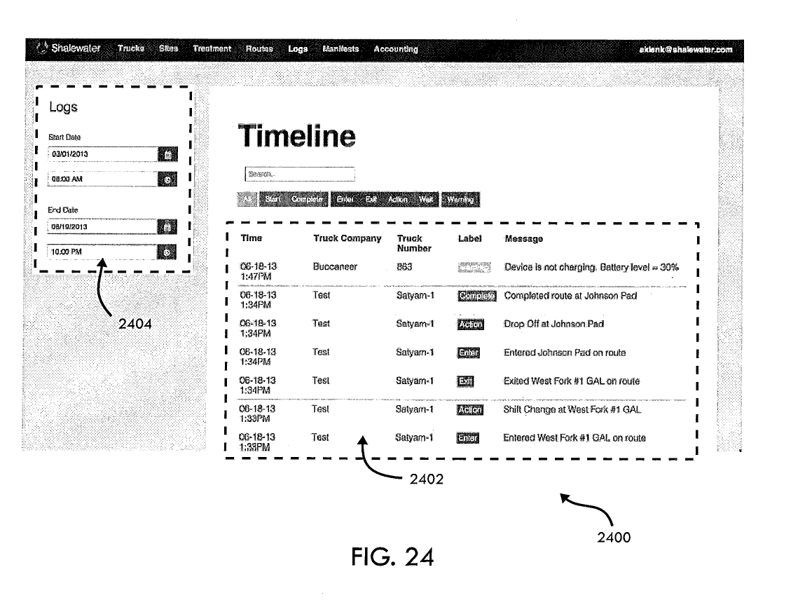

Referring now to FIG. 24, a log GUI 2400 is shown according to a preferred and non-limiting embodiment. An activity log 2402 may display selected data, or the most recently logged data, in a tabular or other like format. Each log entry may include a date and/or time, a company name, a truck number, a label, and a message, as examples. The labels may indicate that a route has been started or completed, that a site or associated boundary has been entered or exited, that an action has occurred, or that an alert or warning has occurred. For example, an alert or warning may be logged when a client device is not plugged into a power supply or if the battery level is below a predetermined threshold. Shift changes may also be logged and displayed in the activity log 2402. Log view options 2404 may include various selectable options to define the scope of the activity log 2402 displayed. For example, a starting date and time and an ending date and time may be input to generate an activity log 2402 for that time range.

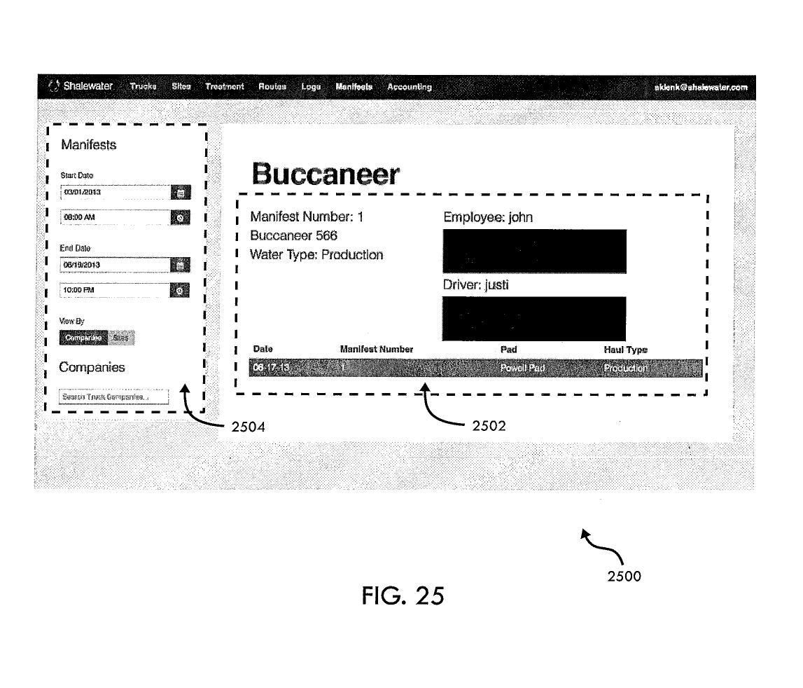

Referring now to FIG. 25, a manifest management GUI 2500 is shown according to a preferred and non-limiting embodiment. A manifest summary 2502 may include a list of manifests and information for a selected manifest such as, but not limited to, a manifest number, a company name, a fluid type, and an image or confirmation of the signatures entered into the fields 2003, 2005 on the manifest signature GUI 2001 shown in FIG. 19. Manifest view options 2504 may be provided to enable a user to search for a manifest or filter a list of manifests by a starting date and time and an ending date and time. The manifest view options may also include selectable options for a user to search manifests by company name and/or site name, as examples.

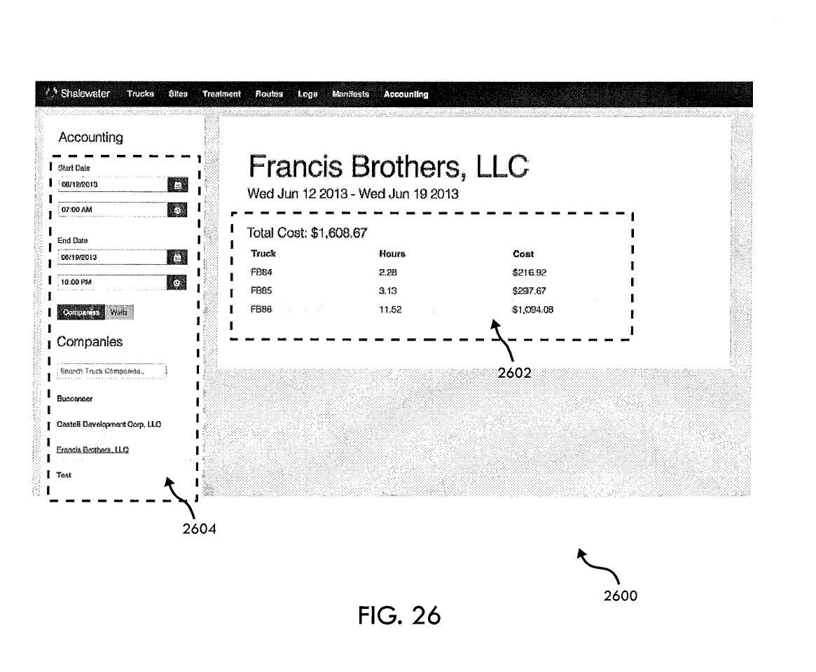

Referring now to FIG. 26, an accounting GUI 2600 is shown according to a preferred and non-limiting embodiment. The accounting GUI 2600 may provide a summary of invoices, payments, and other financial information. Accounting options 2604 may be provided to create an account summary, invoice, or financial report. The accounting options 2604 may include, for example, a starting date and time and an ending date and time. The accounting options 2604 may also allow a user to search or generate an invoice or report based on a company name, a site, and/or a well. It will be appreciated that other parameters may also be used. An account summary 2602 may be displayed based on the accounting options 2604 selected by the user, and may be provided in any number of formats. FIG. 26 illustrates an account summary or invoice for the Francis Brothers LLC from Jun. 12, 2013 to Jun. 19, 2013. In non-limiting embodiments, various options may be provided to generate invoices based on predetermined parameters and/or at predetermined intervals. In non-limiting embodiments, the system 1000 may integrate with existing accounting systems to import and/or export data.

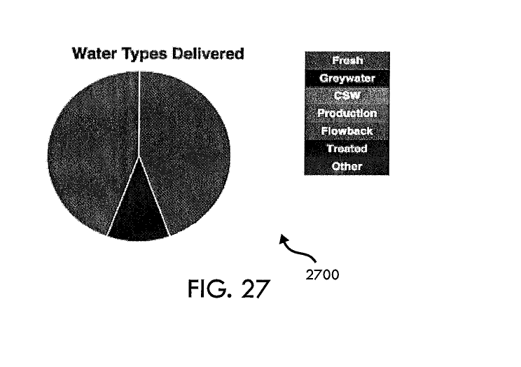

In a preferred and non-limiting embodiment, the management GUIs shown in FIGS. 20-25 may be provided with various features to allow for fast page loads, searching, and filtering. For example, auto-complete may be used in the text input fields for quick searching and filtering. Moreover, changing a date and/or time range may automatically update the visible results without requiring any additional user input. Various charts, graphs, and export options may be provided to visualize the data and to interact with the data in various ways. Referring now to FIG. 27, an example chart 2700 is shown according to one non-limiting embodiment. The chart 2700 illustrates the relative amounts of various fluid types.

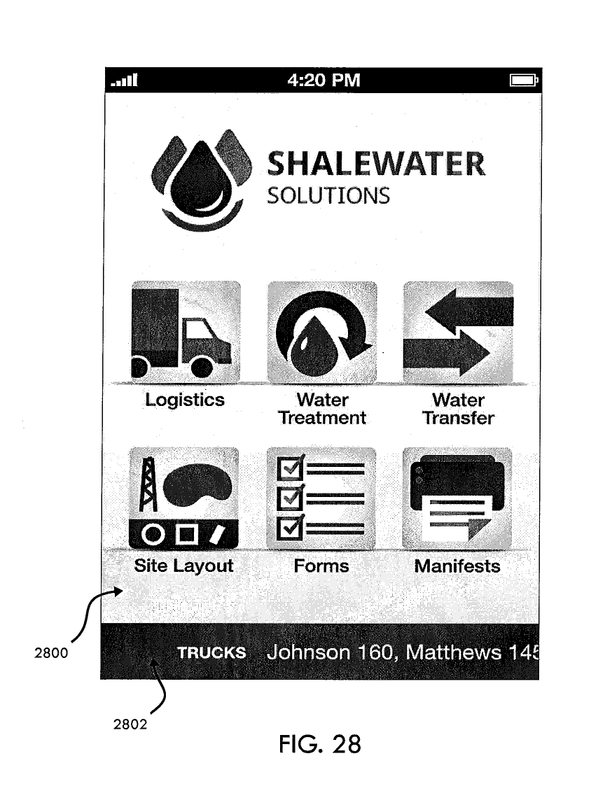

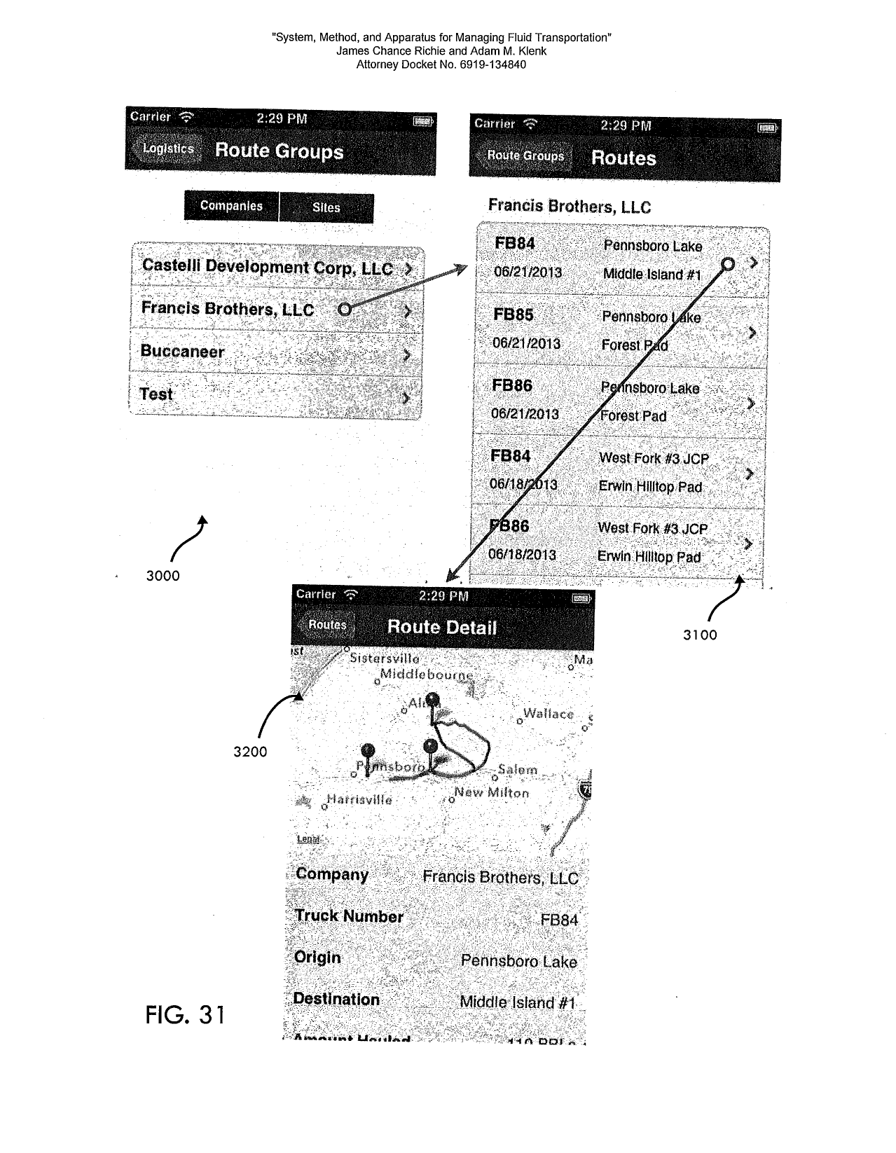

The management GUIs shown in FIG. 20-26, and similar managerial and/or administrative interfaces, may be implemented on a mobile device such as, for example, a smart phone or tablet computer. Referring now to FIGS. 28-38, a series of mobile management GUIs are shown according to certain preferred and non-limiting embodiments, all of which are programmable, configurable, and/or adaptable to any specified application or environment. Specifically referring to FIG. 28, an administrative menu GUI 2800 is shown according to a non-limiting embodiment. The administrative menu may include selectable options for logistics, fluid treatment, fluid transfer, site layout, forms, and manifests, as examples. An information bar 2802 may be included on the administrative menu GUI 2800 or any other GUI. The information bar 2802 may include, for example, a ticker or stream of recently logged activity. The ticker may include indications of various drop-offs, as an example.

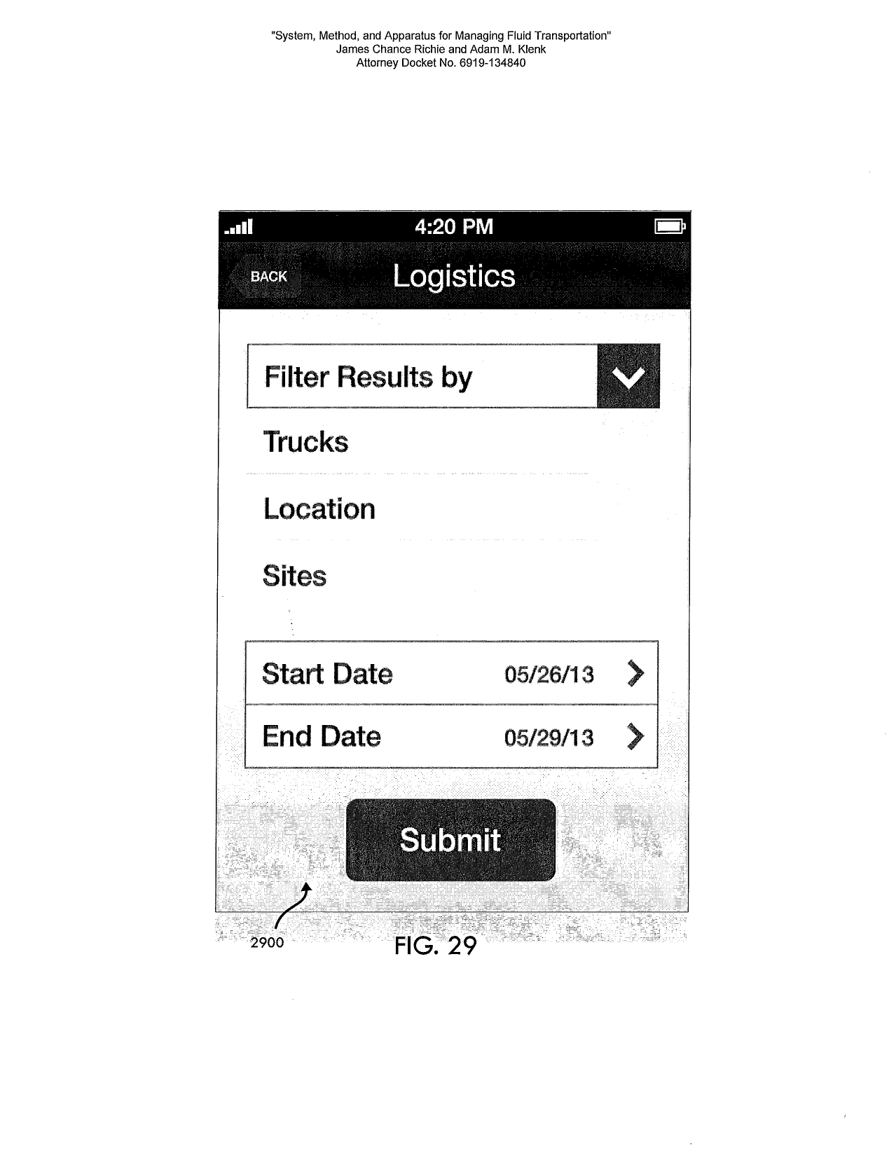

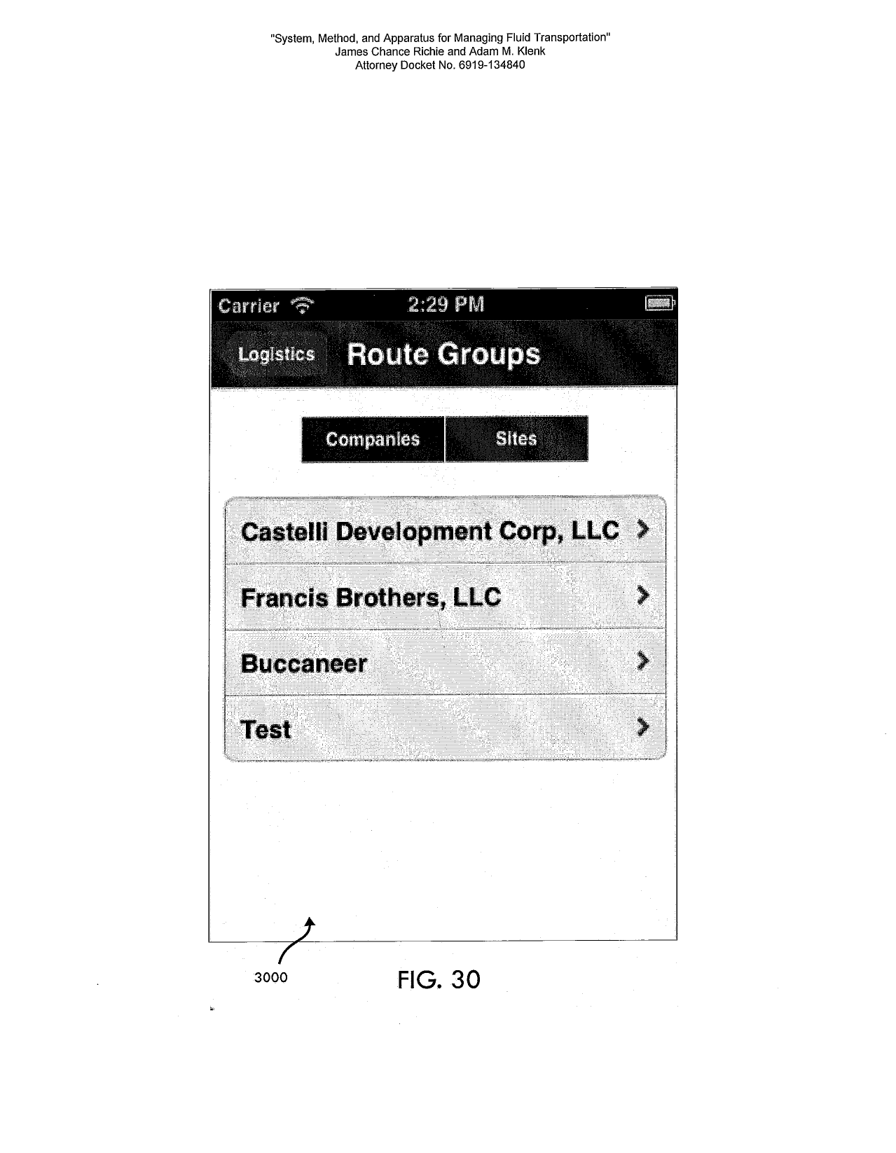

Referring now to FIG. 29, an administrative logistics GUI 2900 is shown according to a preferred and non-limiting embodiment. The administrative logistics GUI 2900 may include selectable options for a user to select a start date and/or time and an ending date and/or time. A filtering option may also be selected by a user, allowing for the results to be filtered by truck company, location, site, well, truck number, driver, and/or the like. Selection of the submit button may submit the query to a server and/or database, and return a user of the mobile device to the route groups GUI 3000 shown in FIG. 30. The route groups GUI 3000 illustrates the results of the query by company, site, well, and/or the like. FIG. 30 illustrates a route groups GUI 3000 that displays the results by company name.

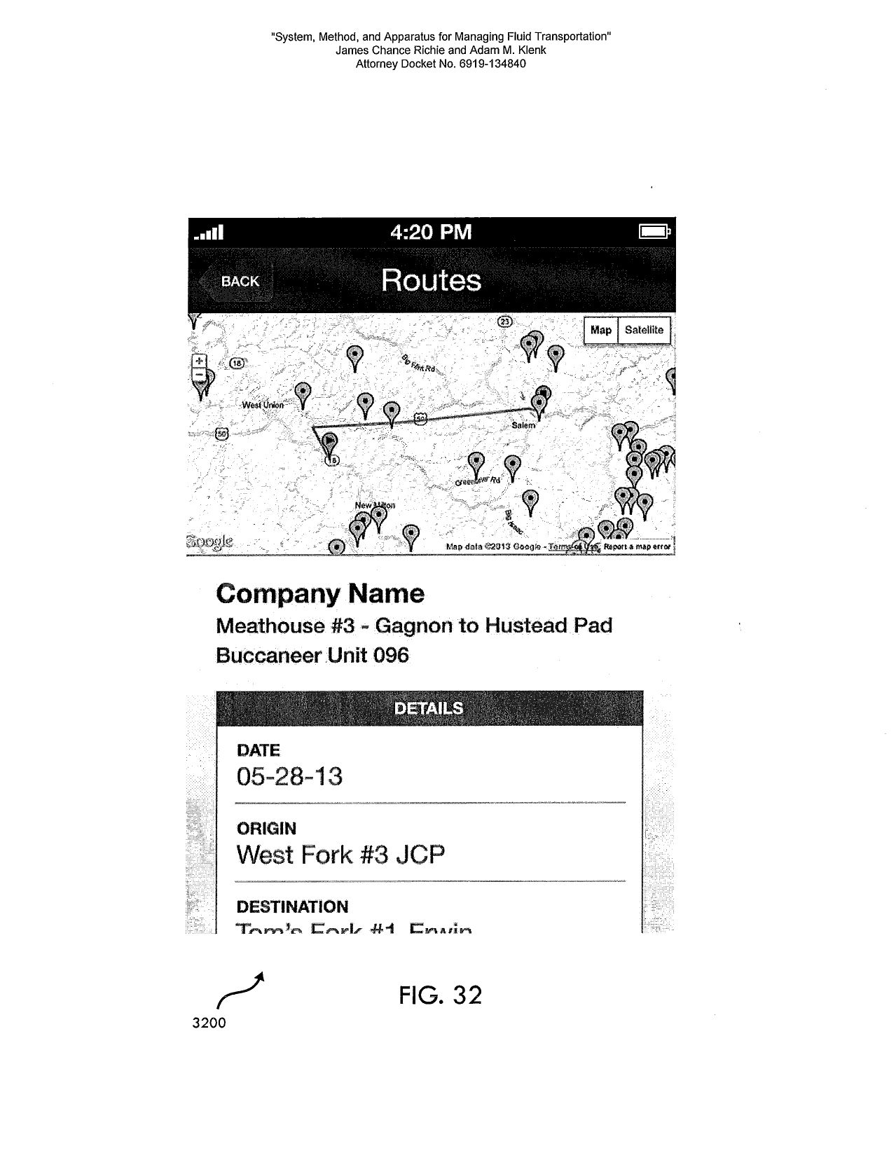

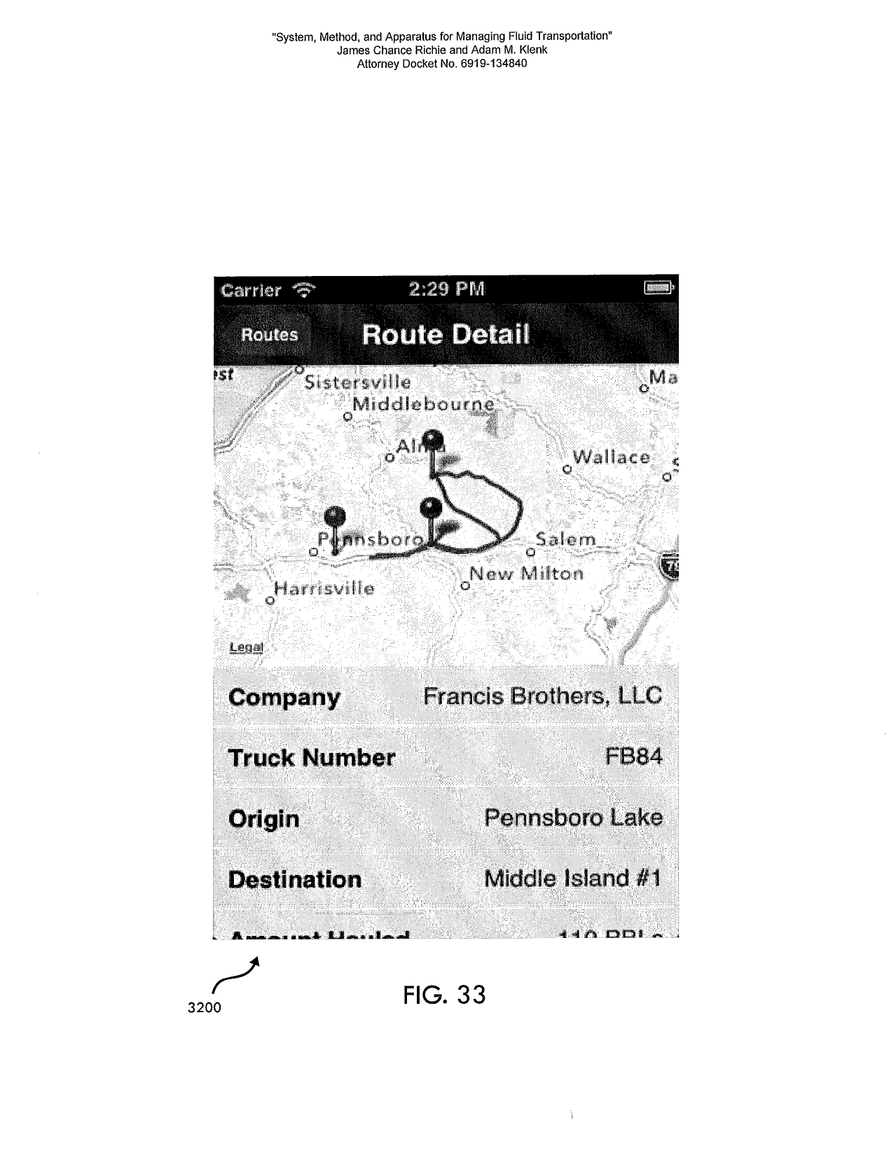

With reference to FIGS. 30-33, selection of a company name from the route groups GUI 3000 may display a route list GUI 3100. The route list GUI 3100 may include one or more routes for a selected company name, site, well, truck, or the like. The route list GUI 3100 may list routes by truck number, date, origin, destination, and/or the like. Selection of a route from the route list GUI 3100 may present a route detail GUI 3200 for the selected route. The route detail GUI 3200 may include route information including, but not limited to, company name, truck number, origin, destination, amount of fluid hauled, and/or the like. FIGS. 32 and 33 show different formats of route detail GUIs 3200.

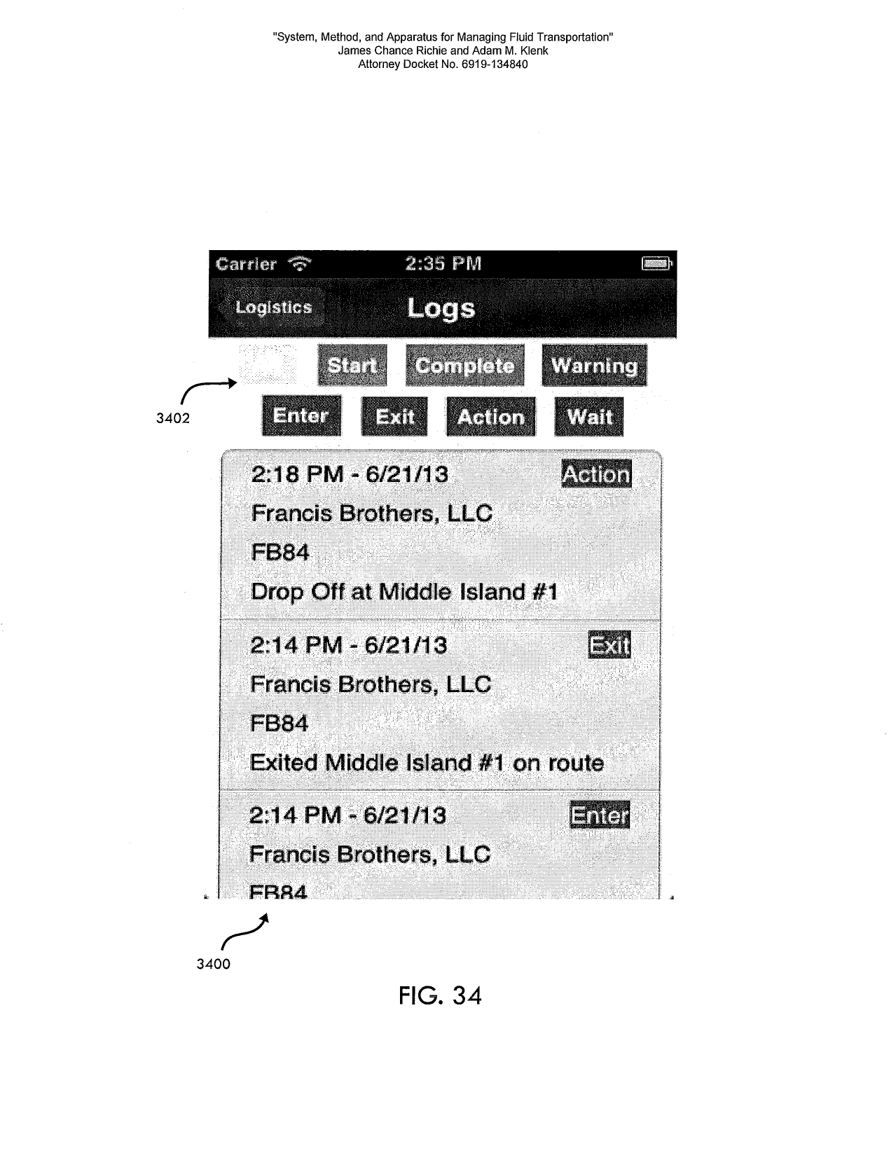

Referring now to FIG. 34, a route log GUI 3400 is shown according to a preferred and non-limiting embodiment. The route log GUI 3400 may include various log entries that indicate that a route has been started or completed, that a site or associated boundary has been entered or exited, that an action has occurred, and/or that an alert or warning has been issued, as examples. Various tags 3402 may be provided to filter the displayed log entries by category. For example, a user can select the “warning” tag to view only the log entries showing an alert or warning.

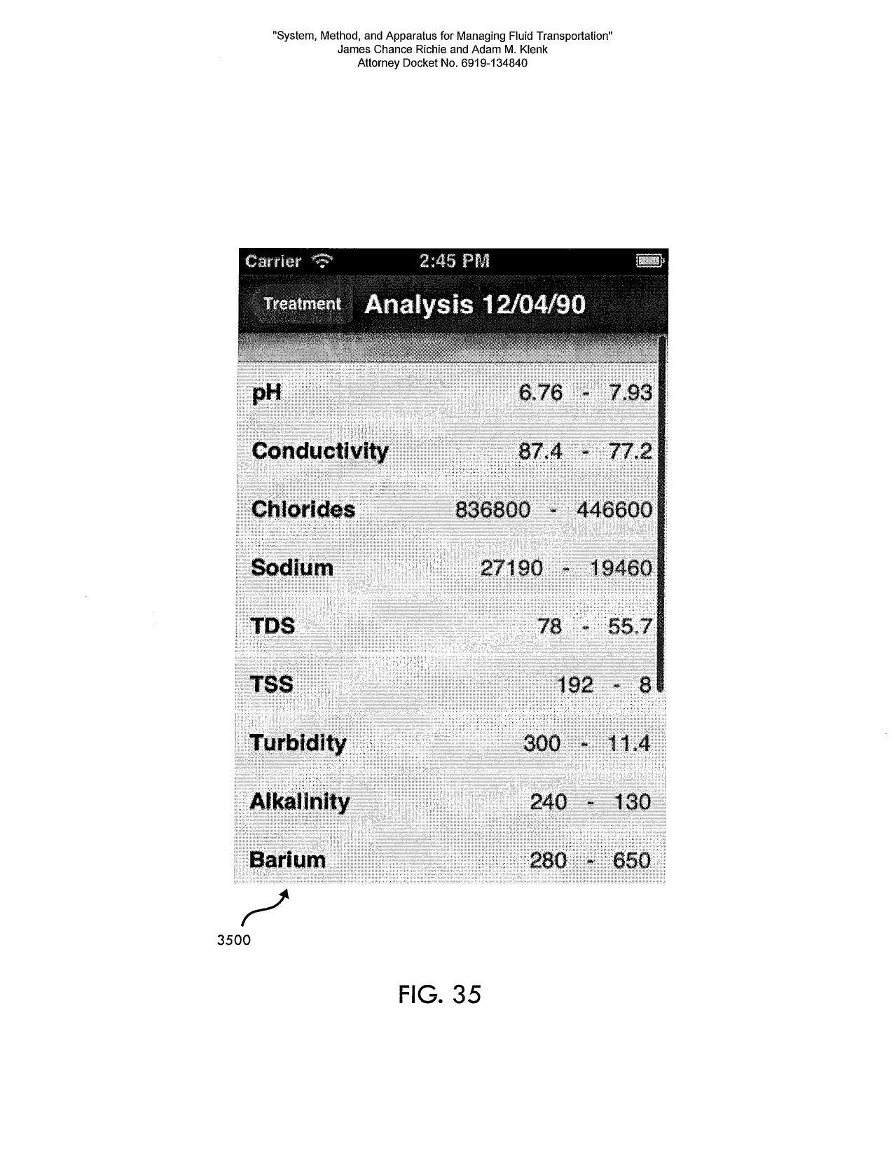

Referring now to FIG. 35, a treatment report GUI 3500 is shown according to a preferred and non-limiting embodiment. The treatment report GUI 3500 may be displayed in response to selection of a treatment option from the administrative menu GUI 2800 shown in FIG. 28. The treatment report GUI 3500 may include some or all of the functionality of the report GUI 2200, shown in FIG. 22 and described herein. In addition, the treatment report GUI 3500 may display analytical results directed to or associated with the water, such as showing the results of testing for pH, conductivity, chlorides, sodium, TDS, TSS, turbidity, alkalinity, barium, and/or other physical or chemical parameters or conditions.

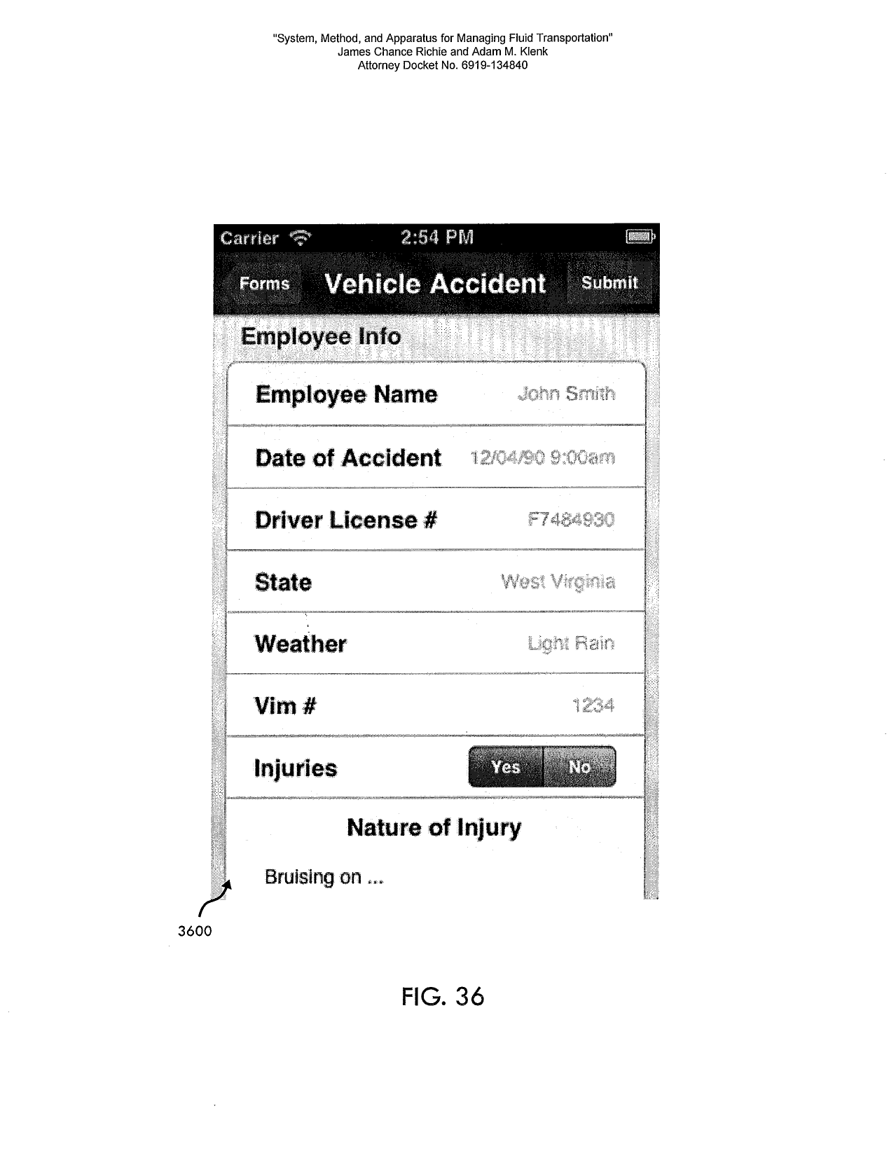

Referring now to FIG. 36, a vehicle accident form GUI 3600 is shown according to a preferred and non-limiting embodiment. The vehicle accident form GUI 3600 may be one of several form GUIs that are displayed in response to selecting a forms option on the administrative menu GUI 2800 shown in FIG. 28. The vehicle accident form GUI 3600 may include fields and selectable options for a user to input various accident parameters including, for example, an employee name, a date of accident, a driver license number, a state, weather conditions, a YIN, an indication of whether there were any injuries, a description of the injuries, and/or the like. A user may complete the form and submit the data to the server. The forms option may also provide other forms such as, but not limited to, employee injury forms to document on-site injuries.

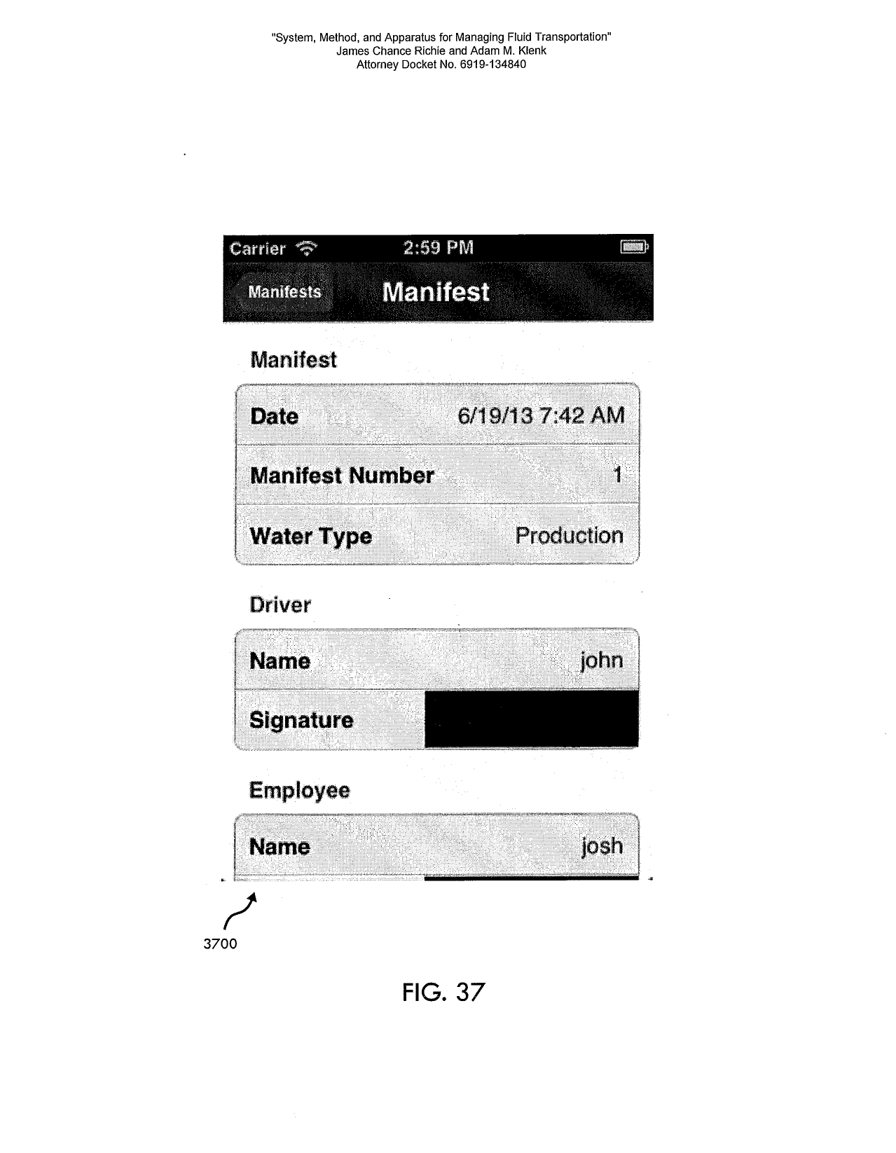

Referring now to FIG. 37, a mobile manifest management GUI 3700 is shown according to a preferred and non-limiting embodiment. The mobile manifest management GUI 3700 may be displayed in response to selection of a manifest option from the administrative menu GUI 2800 shown in FIG. 28, and may include some or all of the functionality of the manifest management GUI 2500 shown in FIG. 25. The mobile manifest management GUI 3700 may display a list of manifests and information for a selected manifest such as, but not limited to, a manifest number, a company name, a fluid type, and an image or confirmation of the signatures entered into the fields 2003, 2005 on the manifest signature GUI 2001 shown in FIG. 19. Options may be provided to enable a user to search for a manifest, or filter a list of manifests by a starting date and/or time and an ending date and/or time, by company name, and/or by site name, as examples.

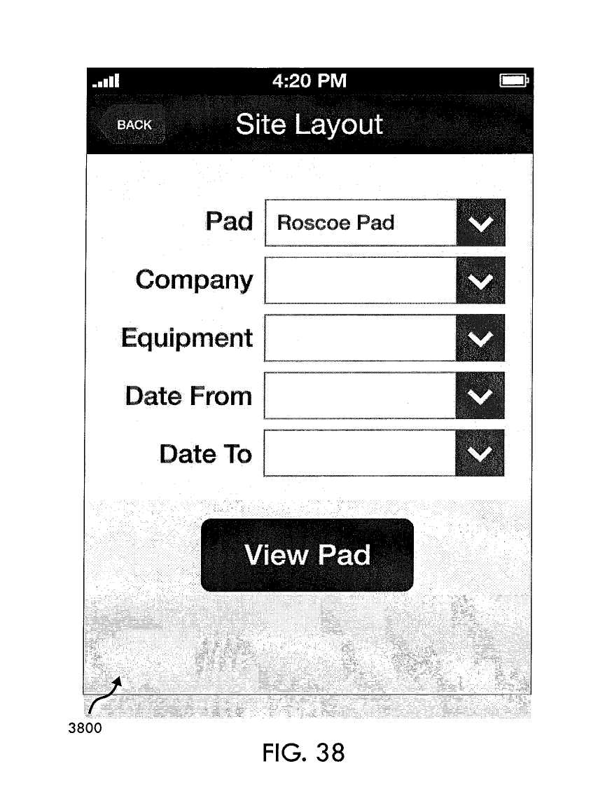

Referring now to FIG. 38, a site layout GUI 3800 is shown according to a preferred and non-limiting embodiment. The site layout GUI 3800 may provide selectable options to choose a pad, company, equipment, and/or date range. Once this information is submitted, a visual representation of a site layout may be provided. Selectable options and tools may be provided to add, remove, or modify existing items, boundaries, or the like at the site based on geographic location.

According to a preferred and non-limiting embodiment, and with reference to FIG. 14, the system may include various monitoring features to monitor the client devices 130, trucks 119, and/or truck drivers. For example, a client device 130 may include an accelerometer or other like sensor and be programmed, configured, and/or adapted to monitor vibrations and to transmit data representing the vibrations to the server 102. By monitoring vibrations of the client device 130, the system 1000 can determine when a client device 130 (and the truck 119 that the client device 130 is in) is traveling, stopped, off-road, or experiencing difficulty. In particular, a manager or administrator may view the client device 130 activity through the management computer 103 in real-time or, in some examples, an alert or notification may be provided based on the monitoring. For example, if the client device 130 reports severe vibrations exceeding a threshold amount or lasting longer than a predetermined amount of time, an alert or notification may be provided to a manager or administrator. Moreover, if the client device reports a lack of movement and vibration for a predetermined amount of time, an alert or notification may be provided to indicate the lack of activity. It will be further appreciated that the accelerometer or other sensor may be located on the truck 119, separate from the client device.

With continue reference to FIG. 14, the system 1000 may monitor the truck drivers in any number of ways. For example, as shown in FIG. 3, the client device 130 may include a camera 137. The camera 137 may be a front-facing camera and be arranged in the cab of the truck 119 such that the camera 137 is pointed toward the driver. For example, the client device 130 may be mounted on the dashboard or elsewhere so that the display is visible to the driver. The client device 130 may be programmed, configured, and/or adapted to allow remote viewing of the data captured by the camera 137, and remote activation and/or control of the camera. In this way, the truck drivers can be remotely monitored from the management computer 103 or elsewhere. A microphone on the client device 130 may also be used to monitor the drivers. The drivers may be visually and/or audibly monitored continuously, at predetermined intervals, or upon an alert or notification. The location of the client device 130 may also be used to monitor the drivers and/or trucks. For example, if a truck enters a site and does not exit the site within a predetermined amount of time, an alert or warning may issue to indicate that the truck and/or driver is idle.

In a preferred and non-limiting embodiment, a volume level on the client device 130 may be monitored by an application running on the client device 130 or on the server 102. If the driver lowers the volume of the client device 130, an alert may be generated and transmitted to the server 102. Additionally, the client device may be configured to prevent modification of the volume level. This functionality can ensure that a driver is provided with all of the instructions and commands necessary during the route.

In a preferred and non-limiting embodiment, each truck 119 is provided with an apparatus adapted to retain the client device 130. For example, a retaining device may be mounted on a dashboard or console of the truck 119 interior, and be connected to a power source on the truck to eliminate concerns regarding battery life. When a driver uses the client device 130 and/or truck 119 for the first time, the client device 130 may be configured to prompt the driver to indicate or select an identifier or name of the truck. Once this set-up process is complete, all information and data recorded and transmitted by the client device 130 may be associated with that specific truck, a specific driver, and/or the like.

In a non-limiting embodiment, the fluid management database 117 may include various types of data from data collection points associated with a truck, site, driver, or combination thereof. For example, a float meter may be positioned at a site in a reservoir or tank to determine the volume of the reservoir or tank and transmit the same to the server 102 for storage. In a non-limiting embodiment, each reservoir or pool of wastewater or fresh water at a drilling or fracking site may have a float meter that, using low-energy Bluetooth, radio frequency, hardwired connections, or various telemetry protocols, transmits volume and/or depth data to a local and/or remote computer, which is then stored in the fluid management database 117 as fluid data associated with that particular site, tank, and/or reservoir. In some examples, the float meters may communicate through a mesh-network, thereby not requiring every node (e.g., every float meter) to have direct accessibility to the local and/or remote computer. In other examples, the float meters may communicate with a remote server 102 via satellite communication or other like technologies. In non-limiting examples, the float meters use ultrasonic measurement techniques to quantify the fluid. Various other arrangements are possible.

In a further non-limiting embodiment, the volume of fluid hauled (e.g., picked-up at a site or dropped-off at a site) may be determined by the weight of the truck. This volumetric data may be the sole source of such data, or may be used to verify the integrity of volumetric data obtained from flow meters and other like devices. For example, a truck may enter a weighing platform or weighing station before and/or after picking-up or dropping-off a haul. The gravimetric data obtained from the weighing station can be used to determine the weight of the truck and contents. One or more processors may be used to subtract the mass of the truck as a known constant (e.g., the weight of the empty truck), and thereby determine the mass of the contents. Using known constants associated with the fluid content, such as the density of the fluid, the volume may be calculated (e.g., volume=mass/density) by the one or more processors and stored in the fluid management database 117 as fluid data associated with the truck, driver, or site. The volume may be represented as barrels or other units. Various other arrangements are possible using the mass of the trucks and/or trailers to determine the volume of fluid hauled.

In further non-limiting embodiments, the client device 130 may comprise an interface to communicate with an on-board diagnostics (OBD) interface/port on the truck, such as but not limited to an OBD II port. With such connectivity, the system may provide analytics data to trucking companies. Real-time or other diagnostic data may be obtained from the OBD port on the truck by the client device 103 and transmitted to the server 102 on a real-time or intermittent basis. Such diagnostic data may include, but is not limited to, miles-per-gallon, speed data, repair data, engine condition data, time-of-use data, and other like analytics.

In a further non-limiting embodiment, the client device 130 is configured to have at least a daytime mode and a nighttime mode. For example, for embodiments in which the client device 130 is mounted to the dashboard or other like surface on the interior of the truck, different color, backlighting, and/or display schemes may be implemented to ensure that the display is visible during the daytime and not overly distracting or bright in the evening For an example, the GUIs displayed during the day may have white or other light backgrounds and dark text, while the GUIs during the night may have dark backgrounds and light text. It will be appreciated that various other arrangements are possible. The display may change based on a light sensor (e.g., a photosensor, a camera unit on the phone, or other like device) that measures ambient light, or on preset timing information on the client device 130 and/or the server 102. Further, in some non-limiting embodiments, the client device 130 may be configured to prevent the driver or other user from exiting one or more software applications. In iOS environments, for example, Guided Access may be used to restrict usage of certain areas of the screen. Other similar techniques and technologies may be used on other platforms, to either disable portions of the touchscreen or otherwise lock one or more screens.

In a non-limiting embodiment, various items and objects at a particular site, including but not limited to tanks, vehicles, buildings, manifolds for unloading or loading trucks, tools, and other equipment may be provided with one or more signal-emitting members configured to transmit one or more signals. Various GPS tracking devices may be used to track equipment and other materials used at a site. For example, the location of portable toilets, tanks, trailers, pumping equipment, telemetry equipment, and/or other like items may be remotely monitored. In one non-limiting embodiment, the signals may be received by various client devices 130 and other receivers on a periodic basis, allowing for site owners and managers to obtain an inventory of equipment and to detect when equipment is removed from the site. Reports including the location of specific equipment may be automatically generated or, in other examples, generated based on submitted queries. Further, in some non-limiting embodiments, the relocation of equipment outside of a predefined area or region may cause an alert or notification to be generated.

In some non-limiting embodiments, the signal-emitting members may include radio frequency identification tags, satellite transmitters, low-energy Bluetooth, wireless network adapters, and/or other like devices. Through the use of low-energy Bluetooth or other like protocols, a mesh-type network may also be formed to allow communication of signals from some objects and equipment that are not within range of a receiver but are within range of a second object or piece of equipment. These signal-emitting members may allow for the client device 130 to detect the proximity to an item or object and therefore alert a driver if the truck is too close to the item or object. For example, this arrangement may be used to alert drivers that they are driving too close to a tank or manifold. This may allow the driver to know how far to back-up, or to otherwise guide the truck once on-site. Those skilled in the art will appreciate that various other arrangements and uses are possible.

In some non-limiting embodiments, fluid data concerning safety precautions taken by drivers and other field workers may be obtained and sent to the server 102. For example, U.S. Provisional Patent Application No. 61/911,023, filed Dec. 3, 2013 and hereby incorporated by reference in its entirety, describes a system and method for verifying connection of a groundwire from a truck to a manifold or grounding unit at a site.

In a non-limiting embodiment, the client devices 130 may be used to monitor and/or log a working time of one or more drivers. For example, if a single driver is driving for a predetermined amount of time, a warning may be issued to alert the driver, a manager, or some other authority that the driver has reached a maximum allowed working time for a given day, week, or month. It will be appreciated that monitoring working time may be used for many purposes, including the calculation of overtime wages, preventing accidents from exhaustion, compliance with regulatory requirements, and/or the like.

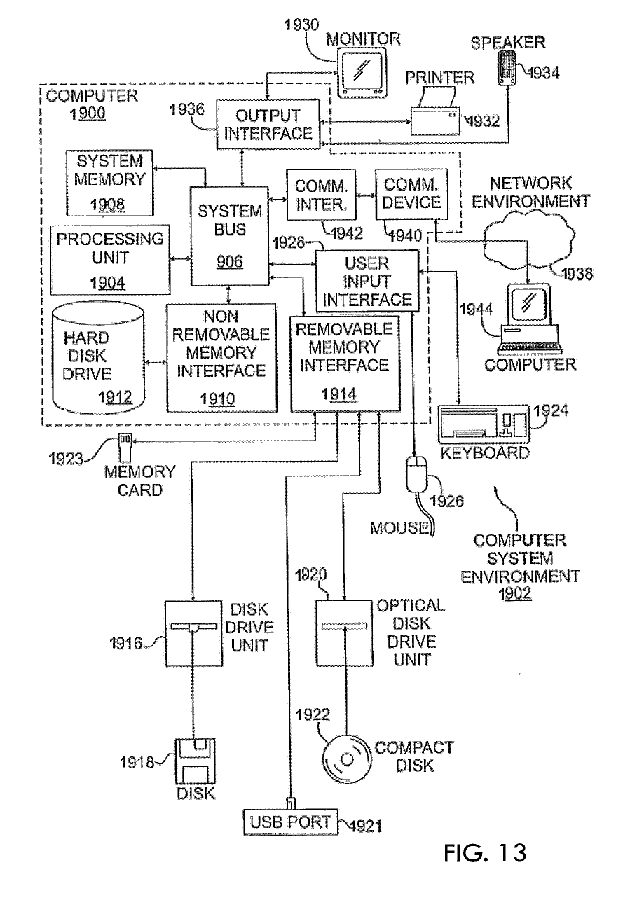

The present invention may be implemented on a variety of computing devices and systems, including the client devices and/or server computer, wherein these computing devices include the appropriate processing mechanisms and computer-readable media for storing and executing computer-readable instructions, such as programming instructions, code, and the like. As shown in FIG. 13, personal computers 1900, 1944, in a computing system environment 1902 are provided. This computing system environment 1902 may include, but is not limited to, at least one computer 1900 having certain components for appropriate operation, execution of code, and creation and communication of data. For example, the computer 1900 includes a processing unit 1904 (typically referred to as a central processing unit or CPU) that serves to execute computer-based instructions received in the appropriate data form and format. Further, this processing unit 1904 may be in the form of multiple processors executing code in series, in parallel, or in any other manner for appropriate implementation of the computer-based instructions.

In order to facilitate appropriate data communication and processing information between the various components of the computer 1900, a system bus 1906 is utilized. The system bus 1906 may be any of several types of bus structures, including a memory bus or memory controller, a peripheral bus, or a local bus using any of a variety of bus architectures. In particular, the system bus 1906 facilitates data and information communication between the various components (whether internal or external to the computer 1900) through a variety of interfaces, as discussed hereinafter.

The computer 1900 may include a variety of discrete computer-readable media components. For example, this computer-readable media may include any media that can be accessed by the computer 1900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 1900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

The computer 1900 further includes a system memory 1908 with computer storage media in the form of volatile and non-volatile memory, such as ROM and RAM. A basic input/output system (BIOS) with appropriate computer-based routines assists in transferring information between components within the computer 1900 and is normally stored in ROM. The RAM portion of the system memory 1908 typically contains data and program modules that are immediately accessible to or presently being operated on by processing unit 1904, e.g., an operating system, application programming interfaces, application programs, program modules, program data and other instruction-based computer-readable codes.

With continued reference to FIG. 13, the computer 1900 may also include other removable or non-removable, volatile or non-volatile computer storage media products. For example, the computer 1900 may include a non-removable memory interface 1910 that communicates with and controls a hard disk drive 1912, i.e., a non-removable, non-volatile magnetic medium; and a removable, non-volatile memory interface 1914 that communicates with and controls a magnetic disk drive unit 1916 (which reads from and writes to a removable, non-volatile magnetic disk 1918), an optical disk drive unit 1920 (which reads from and writes to a removable, non-volatile optical disk 1922, such as a CD ROM), a Universal Serial Bus (USB) port 1921 for use in connection with a removable memory card, etc. However, it is envisioned that other removable or non-removable, volatile or non-volatile computer storage media can be used in the exemplary computing system environment 1900, including, but not limited to, magnetic tape cassettes, DVDs, digital video tape, solid state RAM, solid state ROM, etc. These various removable or non-removable, volatile or non-volatile magnetic media are in communication with the processing unit 1904 and other components of the computer 1900 via the system bus 1906. The drives and their associated computer storage media discussed above and illustrated in FIG. 13 provide storage of operating systems, computer-readable instructions, application programs, data structures, program modules, program data and other instruction-based computer-readable code for the computer 1900 (whether duplicative or not of this information and data in the system memory 1908).

A user may enter commands, information, and data into the computer 1900 through certain attachable or operable input devices, such as a keyboard 1924, a mouse 1926, etc., via a user input interface 1928. Of course, a variety of such input devices may be utilized, e.g., a microphone, a trackball, a joystick, a touchpad, a touch-screen, a scanner, etc., including any arrangement that facilitates the input of data, and information to the computer 1900 from an outside source. As discussed, these and other input devices are often connected to the processing unit 1904 through the user input interface 1928 coupled to the system bus 1906, but may be connected by other interface and bus structures, such as a parallel port, game port, or a universal serial bus (USB). Still further, data and information can be presented or provided to a user in an intelligible form or format through certain output devices, such as a monitor 1930 (to visually display this information and data in electronic form), a printer 1932 (to physically display this information and data in print form), a speaker 1934 (to audibly present this information and data in audible form), etc. All of these devices are in communication with the computer 1900 through an output interface 1936 coupled to the system bus 1906. It is envisioned that any such peripheral output devices be used to provide information and data to the user.

The computer 1900 may operate in a network environment 1938 through the use of a communications device 1940, which is integral to the computer or remote therefrom. This communications device 1940 is operable by and in communication to the other components of the computer 1900 through a communications interface 1942. Using such an arrangement, the computer 1900 may connect with or otherwise communicate with one or more remote computers, such as a remote computer 1944, which may be a personal computer, a server, a router, a network personal computer, a peer device, or other common network nodes, and typically includes many or all of the components described above in connection with the computer 1900. Using appropriate communication devices 1940, e.g., a modem, a network interface or adapter, etc., the computer 1900 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 1900, 1944 may be used.

As used herein, the computer 1900 includes or is operable to execute appropriate custom-designed or conventional software to perform and implement the processing steps of the method and system of the present invention, thereby, forming a specialized and particular computing system. Accordingly, the presently-invented method and system may include one or more computers 1900 or similar computing devices having a computer-readable storage medium capable of storing computer-readable program code or instructions that cause the processing unit 1902 to execute, configure or otherwise implement the methods, processes, and transformational data manipulations discussed hereinafter in connection with the present invention. Still further, the computer 1900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system for managing fluid transportation, comprising:
at least one client device configured to: receive fluid source data from at least one fluid source data resource at a pick-up location, the fluid source data comprising at least one of the following: a fluid volume, a fluid type, a fluid flow rate, a pick-up location identifier, a pick-up location name, geographic coordinates of a pick-up location, a pick-up time, a pick-up date, or any combination thereof; and receive fluid destination data from at least one fluid destination data resource at a drop-off location, the fluid destination comprising at least one of the following: a fluid volume, a fluid type, a fluid flow rate, a drop-off location identifier, a drop-off location name, geographic coordinates of a drop-off location, or any combination thereof;
at least one server computer in communication with the at least one client device, the at least one server computer configured to receive fluid data comprising at least a portion of the fluid source fluid data and at least a portion of the fluid destination data from the at least one client device; store the fluid data; and generate at least one report based at least partially on the fluid data.

2. The system of claim 1, further comprising:
at least one fluid source data resource located proximate to the at least one pick-up location, the at least one fluid source data resource comprising the fluid source data; and
at least one fluid destination data resource located proximate to the at least one drop-off location, the at least one fluid destination data resource comprising the fluid destination data.

3. The system of claim 1, wherein the at least one client device is further configured to scan the at least one first data resource and the at least one second data source, and wherein the fluid data comprises at least a portion of the at least one first data source and the at least one second data source.

4. The system of claim 2, further comprising at least one vehicle data resource affixed to at least one hauling vehicle, the at least one vehicle data resource comprising vehicle data representing at least one of the following: a trucking company name, a trucking company identifier, a truck capacity, a driver name, a truck identifier, a truck name, or any combination thereof

5. The system of claim 2, wherein the at least one first data source comprises at least one first indicia and the at least one second data source comprises at least one second indicia, the at least one first indicia and the at least one second indicia comprising at least one matrix barcode.

6. The system of claim 1, wherein the fluid data comprises at least one fluid flow rate, and wherein the at least one fluid flow rate is received by the at least one client device from a flow meter in communication with the at least one client device.

7. The system of claim 1, wherein the at least one server computer comprises a back-end module and a user module.

8. The system of claim 7, wherein the back-end module is configured to provide a management user interface to at least one management computer, and wherein the front-end module is configured to provide a mobile user interface to the at least one client device.

9. The system of claim 1, wherein the at least one server computer is further configured to provide a trucking company management interface, and receive truck data for at least one trucking company from the at least one server computer, the truck data comprising at least one of the following: a name of the trucking company, a location of a truck yard, a billing address of the trucking company, a physical address of the trucking company, a billing point of contact of the trucking company, an operations point of contact of the trucking company, or any combination thereof.

10. The system of claim 1, wherein the at least one client device is further configured to display a well management interface, and receive well data for at least one well from the at least one server computer, the well data comprising at least one of the following: a name of the well, a well pad associated with the well, a pit associated with the well, a pond associated with the well, a location of the well, or any combination thereof.

11. The system of claim 1, wherein the server computer is further configured to display a reports interface, the reports interface configured to generate or retrieve at least one report based at least partially on at least one of the following options: a truck number, a trucking company name, a location, a fluid type, a date range, a well name, a cost, or any combination thereof.

12. The system of claim 1, wherein the server computer is further configured to provide a menu interface to the at least one client device, the menu interface comprising at least one of the following options: a user management interface option, a trucking management interface option, a location management interface option, a reports interface option, or any combination thereof.

13. A computer-implemented method for managing transportation of a fluid, comprising:
receiving, on a mobile device, fluid source data from a fluid pick-up location, the fluid source data representing at least two of the following: a type of fluid, geographic coordinates of the pick-up location, a name of the pick-up location, an identifier of the pick-up location, a volume of the fluid, a pick-up time, a fluid pick-up date, or any combination thereof;
receiving, on the mobile device, fluid destination data from a fluid drop-off location, the fluid data representing at least one of the following: geographic coordinates of the drop-off location, a name of the drop-up location, an identifier of the drop-off location, a volume of the fluid, a drop-off capacity, a drop-off time, a drop-off date, or any combination thereof; and
transmitting, to at least one server computer, at least a portion of the fluid source data and the fluid destination data.

14. The computer-implemented method of claim 13, further comprising receiving, on a mobile device, truck data representing at least one of the following: a trucking company name, a trucking company identifier, a truck capacity, a driver name, a truck identifier, a truck name, or any combination thereof.

15. The computer-implemented method of claim 13, wherein at least one of the fluid source data and the fluid destination data is received on the mobile device by scanning, with the mobile device, at least one of a pick-up indicia and a drop-off indicia.

16. The computer-implemented method of claim 15, wherein at least one of the pick-up indicia and drop-off indicia comprise a matrix barcode.

17. The computer-implemented method of claim 13, further comprising providing at least one of the following: a log-on interface, a menu interface, a report interface, or any combination thereof.

18. The computer-implemented method of claim 13, further comprising determining, based at least partially on the pick-up time and the drop-off time, a total hauling time.

19. The computer-implemented method of claim 18, further comprising generating an expense report based at least partially on the total hauling time.

20. The computer-implemented method of claim 19, wherein the expense report is generated based at least partially on at least one of the following: a user group, a fluid volume, a truck identifier, a driver name, the type of fluid, the geographic coordinates of the pick-up location, the name of the pick-up location, the identifier of the pick-up location, the geographic coordinates of the drop-off location, the name of the drop-up location, the identifier of the drop-off location, or any combination thereof.
